(19) United States
(12) Patent Application Publication
(10) Pub. No.: US 2011/0111881 A1
(43) Pub. Date: May 12, 2011

(54) Releasable And Interchangeable Connections For Golf Club Heads And Shafts

(75) Inventors: Raymond J. Sander, Benbrook, TX (US); Gregory A. Trees, Columbus, OH (US); Matthew P. Rubal, Columbus, OH (US); Michael S. Ulrich, Columbus, OH (US); Timothy J. Lastrapes, Upper Arlington, OH (US); Matthew S. Young, Columbus, OH (US)

(73) Assignee: NIKE, Inc., Beaverton, OR (US)

(21) Appl. No.: 12/944,458

(22) Filed: Nov. 11, 2010

Related U.S. Application Data
(63) Continuation-in-part of application No. 12/509,217, filed on Jul. 24, 2009.
Application No. 12/509,217 is a continuation-in-part of application No. 12/366,484, filed on Feb. 5, 2009.

(51) Int. Cl. A63B 53/02; B23P 11/00

(52) U.S. Cl. 473/307; 29/525.02; 473/314

(57) ABSTRACT

Golf club heads are releasably engaged with shafts so they may be readily interchanged and/or so that the shaft orientation with respect to the club head can be readily changed. Assemblies for connecting the club head and shaft may include a shaft adapter and a head adapter. The shaft adapter may have an exterior surface extending along a first axis and a bore having a cross-sectional shape along a second axis configured to attach to a shaft member. The second end of the shaft adapter may have a cross-sectional shape of a regular polygon or a cross-sectional shape defined by splines. The head adapter has a first end and a second end along a first axis and a bore having either a shape of a regular polygon or a cross-sectional shape defined by splines along a second axis that is shaped to receive the second end of the shaft adapter in a plurality of orientations.

### RELATED APPLICATIONS

This application is a continuation-in-part application of U.S. patent application Ser. No. 12/509,217 filed Jul. 24, 2009 which is continuation-in-part application of U.S. patent application Ser. No. 12/366,484, filed Feb. 5, 2009, which are hereby incorporated by reference in their entirety.

### FIELD OF THE INVENTION

This invention relates generally to golf clubs and golf club heads. More particularly, aspects of this invention relate to golf clubs having releasable connections between the golf club head and the shaft and head/shaft position adjusting features to allow easy interchange of shafts and heads and to allow easy modification of the head/shaft positioning properties. Additionally, features of this invention are similar in structure and function to features of the invention as described, for example, in U.S. patent application Ser. No. 11/774,513 filed Jul. 6, 2007 in the names of Gary G. Tavares, et al., which application is entirely incorporated herein by reference.

### BACKGROUND

Golf is enjoyed by a wide variety of players—players of different genders and dramatically different ages and/or skill levels. Golf is somewhat unique in the sporting world in that such diverse collections of players can play together in golf events, even in direct competition with one another (e.g., using handicapped scoring, different tee boxes, in team formats, etc.), and still enjoy the golf outing or competition. These factors, together with the increased availability of golf programming on television (e.g., golf tournaments, golf news, golf history, and/or other golf programming) and the rise of well known golf superstars, at least in part, have increased golf's popularity in recent years, both in the United States and across the world.

Golfers at all skill levels seek to improve their performance, lower their golf scores, and reach that next performance “level.” Manufacturers of all types of golf equipment have responded to these demands, and in recent years, the industry has witnessed dramatic changes and improvements in golf equipment. For example, a wide range of different golf ball models now are available, with balls designed to complement specific swing speeds and/or other player characteristics or preferences, e.g., with some balls designed to fly farther and/or straighter; some designed to provide higher or flatter trajectories; some designed to provide more spin, control, and/or feel (particularly around the greens); some designed for faster or slower swing speeds; etc. A host of swing and/or teaching aids also are available on the market that promise to help lower one's golf scores.

Being the sole instrument that sets a golf ball in motion during play, golf clubs also have been the subject of much technological research and advancement in recent years. For example, the market has seen dramatic changes and improvements in putter designs, golf club head designs, shafts, and grips in recent years. Additionally, other technological advancements have been made in an effort to better match the various elements and/or characteristics of the golf club and characteristics of a golf ball to a particular user's swing features or characteristics (e.g., club fitting technology, ball launch angle measurement technology, ball spin rates, etc.).

Given the recent advances, there is a vast array of golf club component parts available to the golfer. For example, club heads are produced by a wide variety of manufacturers in a variety of different models. Moreover, the individual club head models may include multiple variations, such as variations in the loft angle, lie angle, offset features, weighting characteristics (e.g., draw biased club heads, fade biased club heads, neutrally weighted club heads, etc.). Additionally, the club heads may be combined with a variety of different shafts, e.g., from different manufacturers; having different stiffnesses, flex points, kick points, or other flexion characteristics, etc.; made from different materials; etc. Between the available variations in shafts and club heads, there are literally hundreds of different club head/shaft combinations available to the golfer.

Club fitters and golf professionals can assist in fitting golfers with a golf club head/shaft combination that suits their swing characteristics and needs. Conventionally, however, golf club heads are permanently mounted to shafts using cements or adhesives. Therefore, to enable a golfer to test a variety of head/shaft combinations, the club fitter or professional must carry a wide selection of permanently mounted golf club head/shaft combinations (which takes up a considerable amount of storage space and inventory costs) or the club fitter or professional must build new clubs for the customer as the fitting process continues (which takes a substantial amount of time and inventory costs). The disadvantages associated with these conventional options serve to limit the choices available to the golfer during a fitting session and/or significantly increase the expense and length of a session.

### SUMMARY

The following presents a general summary of aspects of the invention in order to provide a basic understanding of the invention and various features of it. This summary is not intended to limit the scope of the invention in any way, but it simply provides a general overview and context for the more detailed description that follows.

Aspects of this invention relate to systems and methods for connecting golf club heads to shafts in a releasable manner so that the club heads and shafts can be readily interchanged and/or so that the angle and/or position of the shaft with respect to the club head body (and its ball striking face) can be readily changed.

Golf clubs in accordance with examples of this invention may include a shaft, a golf club head having a hosel area and an interior chamber defined in a bottom of the club head, a shaft adapter engaged with the shaft, and a head adapter. The shaft adapter may have a first end and a second end along a first axis. Additionally, the shaft adapter may further comprise a bore extending along a second axis, wherein one end of the shaft extends into the bore on the second axis, and wherein at least a portion of an exterior surface of the shaft adapter has a noncircular cross-sectional shape. Additionally, the second end may include a securing structure. The head adapter may have a first end and a second end along a first axis. The head adapter may further comprise a bore having a noncircular cross-sectional shape along a second axis that is shaped to receive and engage the portion of the exterior surface of the shaft adapter having the noncircular cross-sectional shape in a non-rotational manner and in a plurality of different orientations.

Additionally, the golf clubs may include a securing member extending into the second end of the shaft adapter and releasably engaging the securing structure of the shaft adapter to thereby releasably engage the shaft adapter and the head adapter to the golf club head. Additionally, the exterior surface of the shaft adapter may engage the hosel area while the interior chamber may provide an opening for receiving the head adapter.

Further aspects of this invention relate to methods of assembling a golf club. According to one exemplary method, a shaft member is attached to the shaft adapter having a first end and a second end along a first axis. The shaft member may be inserted within a bore defined in the shaft adapter along a second axis, wherein at least a portion of an exterior surface of the shaft adapter has a noncircular cross-sectional shape, and the second end includes a securing structure. The method may further comprise inserting a head adapter into an interior chamber of a club head. The method may further comprise inserting the shaft adapter within a bore of the head adapter, wherein the head adapter comprises a first end and a second end along a first axis and wherein the bore has a noncircular cross-sectional shape along a second axis that is shaped to receive and engage the portion of the exterior surface of the shaft adapter having the noncircular cross-section in a non-rotational manner and in a plurality of different orientations. The method may further comprise placing a securing member into the second end of the shaft adapter. Additionally, the method may further comprise releasably engaging the securing member with the securing structure of the shaft adapter to thereby releasably engage the head adapter and the shaft adapter with the club head.

### BRIEF DESCRIPTION OF THE DRAWINGS

A more complete understanding of the present invention and certain advantages thereof may be acquired by referring to the following detailed description in consideration with the accompanying drawings, in which:

FIG. 1 generally illustrates a frontal view of an exemplary golf club according to embodiments of the invention;

FIG. 2 is a cross-sectional perspective view of an example shaft adapter according to certain embodiments of the invention;

FIG. 3 is a cross-sectional perspective view of an example head adapter engaging a shaft adapter according to certain embodiments of the invention;

FIG. 4 is an exploded view of an example golf club having a shaft adapter and a head adapter according to one embodiment of the invention;

FIGS. 5A and 5B illustrate the rotation of an example shaft adapter in relation to a club head according to one embodiment of the invention;

FIGS. 5C and 5D illustrate the rotation of an exemplary shaft adapter and an exemplary head adapter in relation to a club head in accordance with one embodiment of the invention;

FIG. 6 shows a table comprising exemplary information relating to the adjustment of the shaft adapter in relation to the club head according to one embodiment of the invention;

FIG. 7 is a cross-sectional perspective view of an example shaft adapter according to another example structure of the invention;

FIG. 8 is a cross-sectional perspective view of an example head adapter engaging a shaft adapter according to another example structure of the invention;

FIG. 9 is an exploded view of an example golf club having a shaft adapter and a head adapter according to another example structure of the invention;

FIGS. 10A and 10B illustrate the rotation of an example shaft adapter in relation to a club head according to one example of the invention;

FIGS. 10C and 10D illustrate the rotation of an exemplary shaft adapter and an exemplary head adapter in relation to a club head in accordance with another example of the invention;

FIGS. 11A and 11B illustrate the interconnection of an example shaft adapter and a head adapter according to alternative examples of the invention;

FIG. 12A illustrates a cross-sectional perspective view of an example shaft adapter/head adapter assembly according to another example structure of the invention;

FIG. 12B is an exploded view of an example golf club having a shaft adapter and a head adapter according to the example structure depicted in FIG. 12A;

FIG. 13A illustrates a cross-sectional perspective view of an example shaft adapter/head adapter assembly according to a further example structure of the invention;

FIG. 13B is an exploded view of an example golf club having a shaft adapter and a head adapter according to the example structure depicted in FIG. 13A;

FIGS. 14A through 14C are detailed views of the shaft adapter according to the example structure depicted in FIGS. 12A and 12B;

FIGS. 15A through 15C are detailed views of the head adapter according to the example structure depicted in FIGS. 12A and 12B;

FIG. 16 is a top perspective view of the shaft adapter/head adapter assembly installed in a club head according to the example structure depicted in FIGS. 12A and 12B; and

FIG. 17 is a bottom perspective view of the shaft adapter/head adapter assembly installed in a club head according to the example structure depicted in FIGS. 12A and 12B.

The reader is advised that the attached drawings are not necessarily drawn to scale.

### DETAILED DESCRIPTION

In the following description of various example structures in accordance with the invention, reference is made to the accompanying drawings, which form a part hereof, and in which are shown by way of illustration various example connection assemblies, golf club heads, and golf club structures in accordance with the invention.

Additionally, it is to be understood that other specific arrangements of parts and structures may be utilized, and structural and functional modifications may be made without departing from the scope of the present invention. Also, while the terms “top,” “bottom,” “front,” “back,” “rear,” “side,” “underside,” “overhead,” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of this invention.

In general, as described above, aspects of this invention relate to systems and methods for connecting golf club heads to shafts in a releasable manner so that the club heads and shafts can be readily interchanged and/or repositioned with respect to one another. Specific examples of the invention are described in more detail below. The reader should understand that these specific examples are set forth merely to illustrate examples of the invention, and they should not be construed as limiting the invention.

### A. EXAMPLES OF SPECIFIC EMBODIMENTS

### 1. Exemplary Club Structure

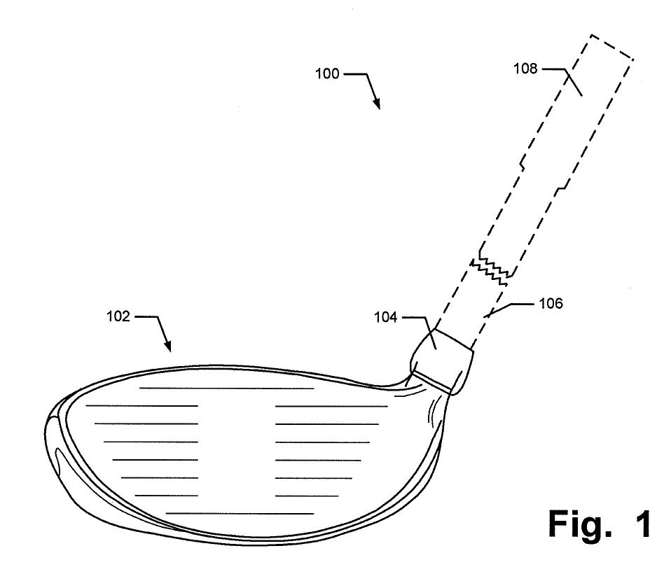

FIG. 1 generally illustrates an exemplary golf club 100 in accordance with at least some embodiments of the invention. Exemplary club 100 includes a club head 102, a releasable club head/shaft connection system 104 that connects the club head 102 to a shaft member 106 (which will be described in more detail below), and a grip member 108 engaged with the shaft member 106. While a driver/wood-type golf club head 102 is illustrated in FIG. 1, aspects of this invention may be applied to any type of club head, including, for example: fairway wood club heads; iron type golf club heads (of any desired loft, e.g., from a 0-iron or 1-iron to a wedge); wood or iron type hybrid golf club heads; putter heads; and the like. The club heads may be made from suitable materials, in suitable constructions, in suitable manners, as are known and used in the art, optionally modified (if necessary, e.g., in size, shape, etc.) to accommodate the releasable club head/shaft connection parts.

The various parts of the club head/shaft connection system 104 may be made from any desired or suitable materials without departing from this invention. For example, one or more of the various parts may be made from a metal material, including lightweight metals conventionally used in golf club head constructions, such as aluminum, titanium, magnesium, nickel, alloys of these materials, steel, stainless steel, and the like, optionally anodized finished materials. Alternatively, if desired, one or more of the various parts of the connection system 104 may be made from rigid polymeric materials, such as polymeric materials conventionally known and used in the golf club industry. The various parts may be made from the same or different materials without departing from this invention. In one specific example, each of the various parts will be made from a 7075 aluminum alloy material having a hard anodized finish. The parts may be made in suitable manners as are known and used in the metal working and/or polymer production arts.

Any desired materials also may be used for the shaft member 106, including suitable materials that are known and used in the art, such as steel, graphite, polymers, composite materials, combinations of these materials, etc. Optionally, if necessary or desired, the shaft may be modified (e.g., in size, shape, etc.) to accommodate the releasable club head/shaft connection parts 104. The grip member 108 may be engaged with the shaft 106 in any desired manner, including in any suitable manners that are known and used in the art (e.g., via cements or adhesives, via mechanical connections, etc.). Any desired materials may be used for the grip member 108, including suitable materials that are known and used in the art, such as rubber, polymeric materials, cork, rubber or polymeric materials with cord or other fabric elements embedded therein, cloth or fabric, tape, etc. Optionally, if desired, the grip member 108 (or any suitable handle member) may be releasably connected to the shaft 106 using a releasable connection like releasable connection 104 (examples of which will be described in more detail below).

The releasable connection 104 between golf club heads and shafts in accordance with some examples of this invention now will be described in more detail in conjunction with FIGS. 2 through 6.

### 2. Exemplary Shaft Adapter

FIG. 2 is a cross-sectional perspective view of an example shaft adapter 202 according to one embodiment of the invention. The shaft adapter 202 may be made from one or more suitable materials as described above and may comprise materials that are different than the materials comprising the remaining sections of the golf club. For example, the shaft adapter 202 may comprise or include rubber or another compressible material that may increase the surface tension and/or reduce movement between the shaft adapter 202, the shaft member 106, and/or the head adapter (302, described below). In yet other embodiments, rubber and/or other materials may be used to increase shock absorbency and/or to reduce noise during a ball strike. In yet other embodiments, the shaft adapter 202 may be constructed from a lightweight metal, metal alloy, or polymeric material (e.g., a rigid polymeric material).

As shown in FIG. 2, shaft adapter 202 has a first end 204 and a second end 206, wherein the first end 204 is along the same axis 208 as the second end 206. The shaft adapter 202 further comprises a bore 210 along a second axis 212 configured to attach to a shaft member 106 on the second axis 212. Thus, the cylindrical exterior of the shaft adapter 202 extends in one axial direction (along axis 208) from the first end 204 to the second end 206, while the cylindrical bore 210 that receives the shaft member 106 extends in a different axial direction (axis 212). Those skilled in the art will readily appreciate upon review of this disclosure that there are various combinations of structural elements and/or processes that may be used to implement the two axes 208, 212 of shaft adapter 202. The angular difference between the first axis 208 and the second axis 212, may be any angle without departing from this invention, e.g., at least 0.25 degrees, at least 0.5 degrees, at least 1 degree, at least 2 degrees, at least 2.5 degrees, at least 4 degrees, or even at least 8 degrees.

In the example embodiment shown in FIG. 2, the bore 210 has a circular cross-sectional shape, e.g., to receive a conventionally shaped round shaft. If desired, however, the cross-sectional shape of the bore 210 may be, for example, a polygon having any number of sides, such as: 12 or fewer sides, 10 or fewer sides, eight or fewer sides, six or fewer sides, or even four or fewer sides. The cross-sectional shape of the bore 210 may be configured to have a size and shape adapted to inhibit rotation of the shaft member 106 with respect to the shaft adapter 202. This may be due to the shaft adapter's bore 210 having the same general polygon shape as the shaft member 106. Yet in other embodiments, only a portion of the bore 210 engages or mates with the shaft member 106, however, the mating prevents rotation of the shaft adapter 202 within the shaft member 106. In some more specific example structures according to the invention, a portion of the shaft member 106 will have a square or rectangular cross-section and the bore 210 of the shaft adapter 202 will include a multi-sided polygon shaped opening (e.g., with 4, 6, 8, 12, or 16 sides) that receives shaft member 106. Alternatively, if desired, the shaft adapter 202 may be permanently engaged with the shaft member 106, e.g., using cements or adhesives, using fusing techniques (such as welding, brazing, or soldering), etc., particularly in example structures in which the bore 210 and the shaft member 106 have round cross-sections.

In some example embodiments, at least one of the bore 210 and/or the shaft member 106 may have a different quantity of “sides” or protrusions than the other, however, the cross-sectional shapes of the various structures still allow the secure insertion of the shaft member 106 within the shaft adapter's bore 210 without allowing the shaft member 106 to rotate freely within the bore 210. In one such embodiment, the number of “sides” of the either the bore 210 or the shaft member 106 is a multiple of the number of sides on the other. Other such rotation-inhibiting structures and arrangements also are possible without departing from this invention. For example, either one or both of the shaft adapter 202 and/or the shaft member 106 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention.

Looking briefly to FIG. 4 (which will be discussed in more detail below), the shaft adapter 202 is configured to securely attach to the shaft member 106. The exemplary shaft adapter 202 may be hollow and may be sized to receive a free end portion of a golf club shaft, such as shaft member 106. Yet in other embodiments, the exemplary shaft adapter 202 may be sized to be received within a hollow portion at the free end of a golf club shaft, such as shaft member 106. Those skilled in the art will readily appreciate that the shaft adapter 202 is not required to be hollow and may securely attach to a club shaft by any suitable methods and mechanisms, including for example, e.g., via cements or adhesives; via welding, brazing, soldering, or other fusing techniques; via mechanical connectors; via a friction fit; etc. In some embodiments, the connection of the shaft adapter 202 to a shaft member 106, may be releasable, so as to allow shafts to be easily and quickly switched. Yet, in other embodiments, the shaft adapter 202 may be integral to or otherwise permanently affixed to the shaft member 106. As further illustrated in FIGS. 2 and 4, the exterior surface of the shaft adapter 202 may be a cross-sectional shape of a regular polygon. The cross-sectional shape may be, for example, a polygon having 16 or fewer sides, 12 or fewer sides, 10 or fewer sides, eight or fewer sides, six or fewer sides, or even four or fewer sides). In other embodiments, the cross-sectional shape of the exterior surface of the shaft adapter may be circular. The cross-sectional shape of the exterior surface of the shaft adapter is configured to have a size and shape adapted to fit into the head adapter (as described below) and inhibit rotation of the shaft adapter 202 with respect to the head adapter 302.

In some embodiments, the exterior sides of the shaft adapter 202, the shaft member 106 and/or the head adapter (discussed below) may be tapered in the axial direction such that the diameter of the component either increases or decreases along the axial direction. This feature can assist in making the shaft adapter 202 easily fit into and slide out of the head adapter and/or avoid the need to maintain extremely strict tolerances in the manufacturing procedures.

### 3. Exemplary Head Adapter

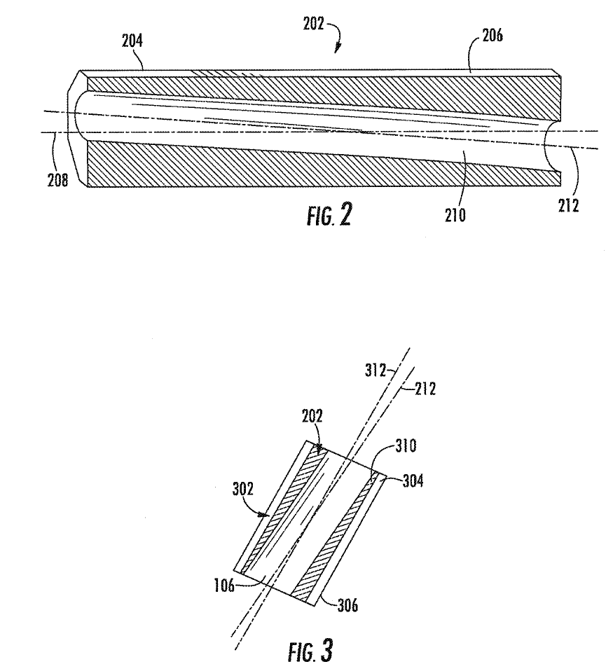

Exemplary connection 104 may further include a head adapter 302. Looking to FIG. 3, the head adapter 302 has a first end 304 and a second end 306. As seen, the first end 304 is along the same axis (not shown) as the second end 306. The head adapter 302 further comprises a bore 310 along a second axis 312 configured to receive the shaft adapter 202 on the second axis 312 (in turn the shaft adapter 202 receives shaft member 106). Thus, the exterior of the head adapter 302 may extend in one axial direction from the first end 304 to the second end 306, while the bore 310 that receives the shaft adapter 202 extends in a different axial direction (axis 312). Those skilled in the art will readily appreciate upon review of this disclosure there are various combinations of structural elements and/or processes that may be used to implement the two axes of head adapter 302 without departing from the scope of the invention. The angular difference between the first axis (not shown) and the second axis 312, may be any angle without departing from this invention, e.g., at least 0.25 degrees, at least 0.5 degrees, at least 1 degree, at least 2 degrees, at least 2.5 degrees, at least 4 degrees, or even at least 8 degrees.

As seen in FIGS. 3 and 4, the bore 310 of the head adapter 302 has the cross-sectional shape of a regular polygon. The cross-sectional shape may be, for example, a polygon having 12 or fewer sides, 10 or fewer sides, eight or fewer sides, six or fewer sides, or even four or fewer sides). The cross-sectional shape of the bore 310 is configured to have a size and shape adapted to inhibit rotation of the shaft adapter 202 with respect to the head adapter 302. This may be due to the head adapter's bore 310 having the same general polygon shape as the exterior surface of the shaft adapter 202, as described above. Yet in other embodiments, only a portion of the bore 310 engages or mates with the shaft adapter 202, however, the mating prevents rotation of the shaft adapter 202 within the head adapter 302. In some more specific example structures according to the invention, the shaft adapter 202 will have a square or rectangular cross-section and the bore 310 of the head adapter 302 will include a multi-sided polygon shaped opening (e.g., with 4, 8, 12, or 16 sides) that receives the shaft adapter 202.

Thus, at least one of the bore 310 and/or the exterior surface of the shaft adapter 202 may have a different quantity of “sides” or protrusions than the other, however, the cross-sectional shapes of the various structures still allow the secure insertion of the shaft adapter 202 within the head adapter's bore 310 without allowing the shaft adapter 202 to rotate freely within the bore 310. In one such embodiment, the number of “sides” of the either the bore 310 or the shaft adapter 202 is a multiple of the number of sides on the other. Still in other embodiments, the bore 310 of the head adapter 302 may have a circular cross-sectional shape, i.e., shaped to receive a shaft adapter 202 with an exterior surface that also has a circular cross-sectional shape. Other such rotation-inhibiting structures and arrangements also are possible without departing from this invention. For example, either or both of the head adapter 302 or the shaft adapter 202 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention.

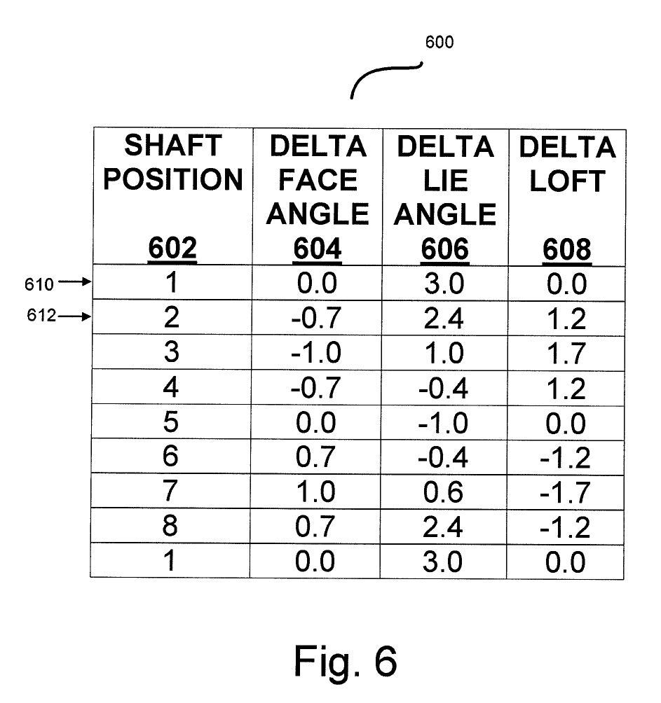

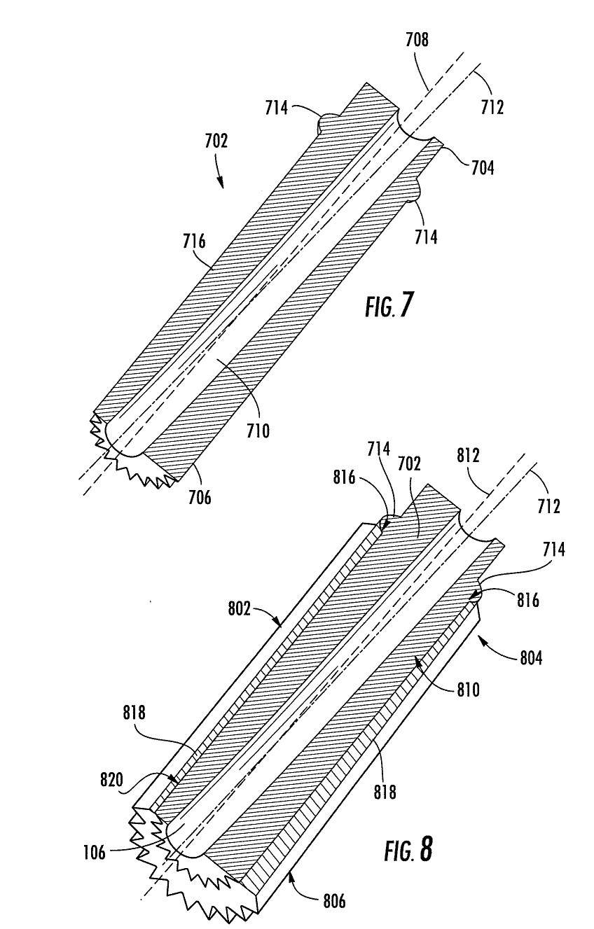

As shown in FIG. 3, the shaft adapter 202 may be configured to fit entirely within the head adapter 302. Yet, in other embodiments, shaft adapter 202 will extend less than 50% of an overall axial length of the head adapter 302, and it may extend less than 35%, less than 25%, or even less than 15% of the overall axial length of the head adapter 302. This feature can help keep the overall connection assembly relatively short, compact, and lightweight. Alternatively, if desired, a portion of the shaft adapter 202 may remain outside the head adapter 302 (and optionally, the exterior shape of the shaft adapter 202 outside of the head adapter may be different from the exterior shape of the shaft adapter 202 located within the head adapter). As discussed below in relation to FIG. 6, the configuration of the shaft adapter 202 and its arrangement with respect to the club head body may be utilized to adjust various positions and/or angles of the ball striking surface of the golf club head 102 (e.g., lie angle, loft angle, face angle, etc.).

In other embodiments, the exemplary head adapter 302 may be sized to be received within a hollow portion, such as the bore 210 of the shaft adapter 202, for example, as described in relation to certain embodiments above where the shaft member 106 fits within the shaft adapter 202. Further, in other embodiments, the head adapter 302 may be integral to or otherwise permanently affixed to a club head 402, such as being received with hosel area 404.

### B. METHODS OF ASSEMBLING

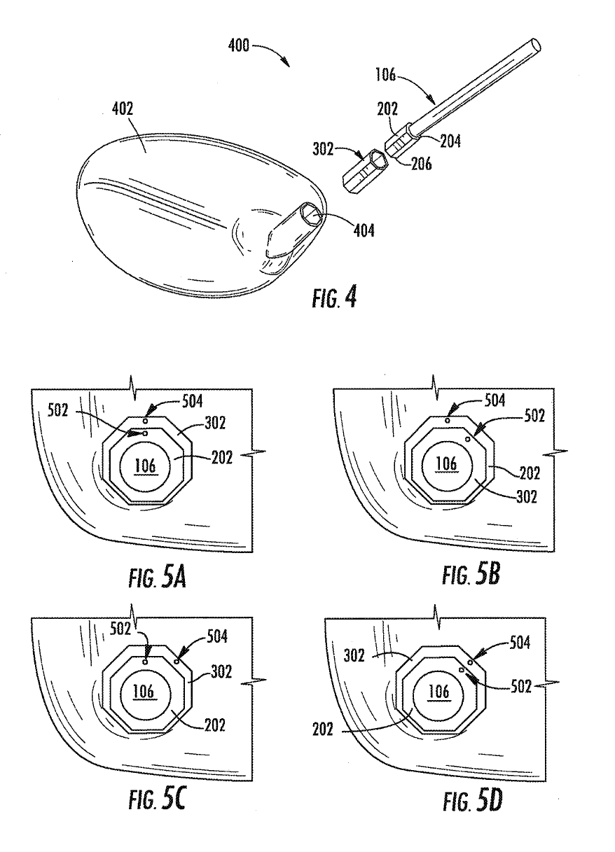

FIG. 4 shows an exploded perspective view of an exemplary golf club 400 according to certain embodiments of the invention. The exploded view of golf club 400 also highlights one of the several methods that may be used for constructing golf clubs according to certain aspects of the invention. According to one exemplary method, the shaft member 106 is attached to the shaft adapter 202 having a first end 204 and a second end 206 along a first axis 208, wherein the shaft member 106 is inserted within a bore 210 extending along a second axis 212 (axis 212 is shown in FIG. 2). The shaft member 106 may be permanently fixed to the shaft adapter 202 (e.g., via cements or adhesives, via fusing techniques (e.g., welding, soldering, or brazing), etc.) or these parts 106 and 202 may be releasably connected to one another. The method may further comprise inserting the second end 206 of the shaft adapter 202 within a bore 310 of a head adapter 302, wherein the head adapter 302 comprises a first end 304 and a second end 306 along a first axis 308 and wherein the bore 310 has the cross-sectional shape of a regular polygon along a second axis 312 that is shaped to receive the second end 206 of the shaft adapter 202 in a plurality of different orientations. The method may further comprise inserting the head adapter 302 into a hosel area 404 of a club head 402 (the hosel area 404 may have an internal opening of a polygon shape shaped to receive the exterior surface of the second end of the shaft adapter 302). In select embodiments, the insertion of the head adapter 302 into the hosel area 404 may be selected from a plurality of different orientations, for example, as discussed below in relation to FIGS. 5A-5D and FIG. 6. Accordingly, further methods may include: removing the shaft adapter 202 from the head adapter 302 and reinserting the second end 206 of the shaft adapter 202 into the bore 310 of the head adapter 302 in a different orientation; and/or removing the head adapter 302 from the hosel area 404 of the club head 402 and reinserting the head adapter 302 into the hosel area 404 of the club head 402 in a different orientation.

Exemplary hosel area 404 may comprise an interior chamber or bore for receiving the head adapter 302. The bore may be machined into the golf club head 402 during manufacturing of the head. In one embodiment, the hosel area 404 is created by drilling or otherwise excavating a portion of golf club head 402. In this regard, at least a portion of the outer perimeter of the hosel area 404 comprises the same materials as the golf club head 402. The shaft member 106 may be secured to the club head 402 (through the shaft adapter 202 and the head adapter 302) in any desired manner, including releasable connection systems that are known and used in the art. For example, a threaded nut provided on the shaft member 106 may engage a threaded portion provided on the hosel. As another example, a threaded bolt may extend through an opening provided in the club head (e.g., in the club head sole) that engages a threaded portion provided in the bottom of the shaft member 106, the shaft adapter 202, and/or the head adapter 302. Other releasable connection systems, like those described in U.S. Pat. No. 6,890,269 (Bruce D. Burrows) and U.S. Published Patent Appln. No. 2004/0018886 (Bruce D. Burrows) may be used without departing from this invention. These patents are each entirely incorporated herein by reference. The connection system may also be releasably engaged in any of the manners described below.

### C. ADJUSTING THE HEAD ADAPTER AND THE SHAFT ADAPTER

Because the axis of the bore 210 in the shaft adapter 202 is offset from the axis of the exterior surface of the shaft adapter 202, and because the axis of the bore in the head adapter 302 is offset from the axis of its exterior surface, rotation of either of these adapters with respect to the club head 402 will change the position of the shaft member 106 with respect to the ball striking face of the club head. FIGS. 5A-5D each show a top view of a portion of a golf club according to various embodiments of the invention where both the shaft adapter 202 and head adapter 302 may be placed in one of several rotational orientations in relation to club head 402. Specifically, looking to FIG. 5A, shaft member 106 is securely retained within shaft adapter 202. As seen, shaft adapter 202 has an outer exterior shape of an octagon, which engages and mates with the head adapter 302, which has an octagon-shaped inner perimeter bore for receiving the shaft adapter 202. As discussed above, the shaft adapter 202 and the head adapter 302 are not required to be the same shape, but rather only required to mate in each other in one of several rotational orientations in relation to one another and/or in relation to the club head 402, for example, as also described below.

The exemplary shaft adapter 202 of FIGS. 5A-5D comprises indicia 502 and the exemplary head adapter 302 comprises indicia 504. Indicia 502 on shaft adapter 202 indicates the rotational position of the shaft adapter 202 with respect to the head adapter 302, and subsequently the club head 402. Indicia 504 on head adapter 302 indicates the rotational position of the head adapter 302 in relation to the club head 402 and also the shaft adapter 202. The indicia 502, 504 are advantageous to allow users to better record the club head/shaft orientation and/or to allow a reliable return to a previous position after rotation of one or more of the components in relation to the shaft member 106 has taken place. Because both the exemplary shaft adapter 202 and the head adapter 302 are generally octagon-shaped in this example structure, there are 64 rotational orientations they may engage and securely mate in a releasable manner. Therefore, the following discussion will refer to the positions of the head adapter 202 and the shaft adapter 302 as being in a rotational position ranging from 1 to 8, where position 1 refers to when the indicia 502, 504 are at the 12 o'clock position in FIG. 5A and the subsequent positions are consecutively numbered in a clockwise fashion. In yet further embodiments, if desired, club head 106 may be marked with indicia.

Depending on how the shaft adapter 202 and/or the head adapter 302 are positioned in relation to the “face” of the club head 102, the playing characteristics of the club may be modified. This feature, along with the releasable connection system 104, allows club fitters (or others) to freely and easily adjust various angles and/or positions of the shaft member 106 with respect to the club head 102 (e.g., variable lie, loft, and face angle combinations) while still using the same shaft 106 and/or head 102, which can help users more easily determine the optimum club head/shaft combination and arrangement to suit their needs. Looking to FIG. 5A, indicia 502 indicates that the shaft adapter 202 is in position 1, and indicia 504 indicates that the head adapter 302 is also in position 1. As seen in FIG. 5B, the shaft adapter 202 (and thus the shaft 106) has been rotated to position 2, while the head adapter 302 remains in position 1.

Repositioning the shaft adapter 202 in relation to the head adapter 302 may be advantageous to adjust the club head/shaft orientation by a known factor. For example, information may be associated with the shaft adapter 202 and the head adapter 302 relating to the angle of the offset-axes of the bores 210, 310. The information may be provided with the adapters 202, 302, may be printed, engraved, or otherwise marked on the adapters 202, 302, themselves, or may otherwise be made available.

FIG. 6 provides table 600 which shows exemplary information relating to adjusting the shaft adapter 202 in relation to the club head 402 (while the head adapter 302 remains at a constant position with respect to the club head 402). The information relates to the example embodiment shown in FIG. 3, where both the shaft adapter 202 and the head adapter 302 are generally octagon shaped. In the specific embodiment, the shaft adapter's bore 210 is offset at about 2 degrees from center and the head adapter's bore 310 is offset at about 1 degree from center, however the offset angle may be within the range of 0.25 to 4 degrees, and in some examples, by an angle within the range of 0.5 to 2 degrees. Table 600 shows the changes to the face angle (column 604), lie angle (column 606), and the loft (column 608) from rotating the shaft adapter 202 with respect to the head adapter 302, one-eighth of the full rotation (or about 45 degrees) in a clock-wise direction. As seen in the first line of column 602, the shaft adapter 202 is set to position 1 (thus as shown in FIG. 5A, indicia 502 is at the 12 o'clock position). When the shaft adapter 202 and the head adapter 302 are set to position 1 (as shown in FIG. 5A), the face angle and the loft are not changed, however, the lie angle is located at +3 degrees (see line 610 of FIG. 6).

When the shaft adapter 202, however, is set to position 2 (or rotated about 45 degrees in the clock-wise direction) and the head adapter 302 remains in position 1, for example, as shown in FIG. 5B, the face angle is adjusted −0.7 degrees, the lie angle changes to +2.4 degrees, and the loft increases 1.2 degrees (See line 612 of FIG. 6). As shown in the remainder of table 600, the face angle, lie angle, and loft may be adjusted to known quantities by repositioning the shaft adapter 202 in relation to the head adapter 302. Further, as shown in FIGS. 5C-5D, the head adapter 302 may also be adjusted, either independently or in combination with the repositioning of the shaft adapter.

In further embodiments, the “sides” of the shaft adapter 202 and/or the head adapter 302 may include protrusions on the perimeter. For example, the components may have a generally circular shape; however, protrusions may be placed or otherwise disposed on the perimeter of the structure such as to create substantially the same effect as the “walls.” Indeed, any structures, shapes, extensions or the like whose characteristics mimic traditional sides are within the scope of the invention and are encompassed within the term “sides” as used herein. In some more specific exemplary structures according to the invention, the rotation inhibiting structure of the interior chamber will have a square or rectangular cross-section. In yet other embodiments, the interior chamber may be irregularly shaped such that the “sides” are not equal. This may be useful, for example, where it is desirable that a shaft not be inserted in a manner that would not provide good club characteristics. In one embodiment, there are a plurality of possible configurations that the shaft adapter may be received within the golf club head, wherein at least one configuration provides different club characteristics than another configuration.

### D. ADDITIONAL ASPECTS OF THE INVENTION

### 1. Generally

The releasable connection assemblies may be provided in any desired structures and/or used in any desired manner without departing from the invention. The clubs with such connection assemblies may be designed for use by the golfer in play (and optionally, if desired, the golfer may freely change shafts, heads, and/or their positioning with respect to one another). As another example, if desired, clubs including releasable connections in accordance with the invention may be used as club fitting tools and when the desired combination of head, shaft, and positioning have been determined for a specific golfer, a club builder may use the determined information to then produce a final desired golf club product using suitable (and permanent) mounting techniques (e.g., cements or adhesives). Other variations in the club/shaft connection assembly parts and processes are possible without departing from this invention.

### 2. Kits

As additional example aspects of this invention, one or more elements or components of a golf club and/or its connection assembly may be marketed, sold, or utilized as a kit. One such embodiment may include a kit comprising a golf club head having an interior chamber configured to receive an insertable head adapter 302. In yet other embodiments, the head adapter 302 may be permanently affixed to or otherwise formed as a part of the golf club head. Additionally or alternatively, the kit further may include the shaft adapter 202 and/or a shaft member 106.

Kits may be associated with instructions for constructing a golf club with the head and choosing between one or more shafts, shaft adapters, and/or other elements to construct a golf club. In certain embodiments, the instructions will describe a method for: inserting a shaft member 106 into the bore 210 at the first end 204 of the shaft adapter 202; inserting the second end 206 of the shaft adapter 202 into the bore 310 of the head adapter 302 in one of a plurality of different orientations; and/or inserting the head adapter 302 into the hosel area of a club head 402, wherein the head adapter 302 may be fit within the hosel area at a plurality of different orientations. In yet further embodiments, the kit may include information relating to the face angle, lie angle, and loft angle of the club head 402 in relation to the different orientations of the shaft adapter 202 and/or the head adapter 302 in the hosel area of the club head 402.

A kit may contain one or more shafts, shaft adapters, heads, and/or instructions depending on the various embodiments. The kits may further comprise information relating to the face angle, lie angle, and loft angle of the club head in relation to an orientation of a specific shaft adapter and/or head adapter in the interior chamber of a specific club head. One skilled in the art will readily appreciate that the instructions are not required to be printed and remain physically present with the other components of the kit, but rather the instructions may be provided on a computer-readable medium. Such instructions may reside on a server that the user may access. In accordance with certain embodiments, the user may be provided information, such as a link to an address on the Internet, which comprises the instructions, which would fall within the scope of providing instructions. Thus, as used herein, providing instructions is not limited to printed copies that are deliverable with a physical element of the golf club.

### 3. Axial Direction Change Regions

Other structures of the golf club 100 may be used in conjunction with the connection system 104 described above in connection with FIGS. 2 through 6 to further increase the benefits of the disclosed golf club. For example, additional structures may further include an axial direction change region. Exemplary shafts having one or more direction change regions are disclosed and described in U.S. patent application Ser. No. 11/774,522 which is entirely incorporated herein by reference. Further, the shaft adapters and/or head adapters described above may be used with other releasable golf club head/shaft connection arrangements, such as those described in U.S. Pat. No. 6,890,269 (Bruce D. Burrows) and U.S. Published Patent Appln. No. 2004/0018886 (Bruce D. Burrows), each of which is entirely incorporated herein by reference. Moreover, various aspects of the invention described above may be used in connection with other patented, pending, and/or commercially available releasable golf club shaft assemblies.

Many variations in the overall structure of the shaft, club head, and club head/shaft connection assembly are possible without departing from this invention. Furthermore, the various steps of the described assembly processes may be altered, changed in order, combined, and/or omitted without departing from the invention. Additionally or alternatively, if desired, in such structures, the club head can be quickly and easily exchanged for a different one on the shaft (e.g., a club head of different loft, lie angle, size, brand, etc.) and/or the shaft can be quickly and easily exchanged for a different one on the club head (e.g., of different material, of different flex, with different kick point characteristics, etc.).

### E. ADDITIONAL FEATURES AND EXAMPLES OF THE INVENTION

Aspects of the invention described herein may be further defined by the following additional example structures. The following example structures are described in reference to the exemplary club structure described above and depicted in FIG. 1. The exemplary elements of these structures (discussed separately below) are depicted together in FIG. 9, which is an exploded perspective view of an exemplary golf club 900 (also discussed below).

1. Exemplary Shaft Adapter

FIG. 7 is a cross-sectional perspective view of an example shaft adapter 702 according to this example of the invention. The example shaft adapter 702 is similar to exemplary shaft adapter 202 described above, however the exterior surface of the shaft adapter 702 may be fully or partially defined by splines 716 (which are also depicted in FIG. 9) extending along the vertical axis 708. The shaft adapter 702 may be made from one or more suitable materials as described above and may comprise materials that are different than the materials comprising the remaining sections of the golf club. For example, the shaft adapter 702 may be constructed from a lightweight metal, metal alloy, or polymeric material (e.g., a rigid polymeric material).

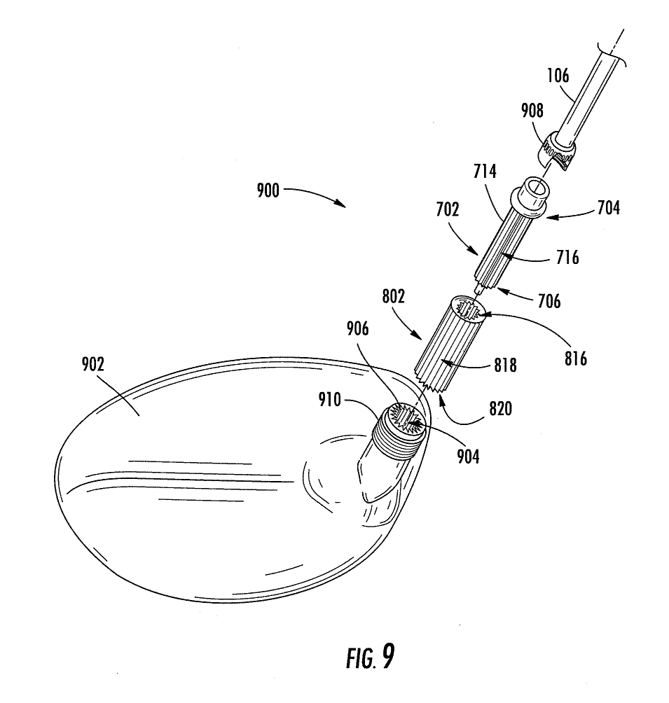

Shaft adapter 702 is generally cylindrically shaped and has a first end 704 and a second end 706 along the same axis 708. Shaft adapter 702 further comprises a bore 710 along a second axis 712 configured to attach to a shaft member 106 on the second axis 712. The exterior of the shaft adapter 702 extends in one axial direction (along axis 708) from the first end 704 to the second end 706, while the cylindrical bore 710 that receives the shaft member 106 may extend in a different axial direction (axis 712). According to the example structure depicted in FIGS. 7-9, the exterior of shaft adapter 702 may further be defined by flange 714, which is adapted to be received by, and mate with, an opening 816 of the head adapter 802 (as shown in FIG. 8). Alternatively, the bottom surface of flange 714 may simply rest against the top surface of head adapter 802. Those skilled in the art will recognize that there are various combinations of structural elements and/or processes that may be used to implement the two axes 708 and 712 of shaft adapter 702. Similar to the example structure 202 described above, the angular difference between the first axis 708 and the second axis 712 of shaft adapter 702, may be any angle without departing from this invention, e.g., at least 0.25 degrees, at least 0.5 degrees, at least 1 degree, at least 2 degrees, at least 2.5 degrees, at least 4 degrees, or even at least 8 degrees.

In the structure shown in FIG. 7, the bore 710 has a circular cross-sectional shape, e.g., to receive a conventionally-shaped round shaft. If desired, however, the cross-sectional shape of the bore 710 may be configured to have a size and shape adapted to inhibit rotation of the shaft member 106 with respect to the shaft adapter 702. For example, the shape of the bore itself may be defined by vertical splines that are shaped to receive and engage a shaft member with a partially splined exterior. As described above with respect to shaft adapter 202, shaft adapter 702 may be configured in a number of ways such that bore 710 engages or mates with the shaft member 106, and such that the mating prevents rotation of the shaft adapter 702 within the shaft member 106. In still other structures, the shaft adapter 702 may be permanently engaged with the shaft member 106 (for example, via cements or adhesives; via welding, brazing, soldering, or other fusing techniques; via mechanical connectors; via a friction fit; etc.) particularly in example structures in which the bore 710 and the shaft member 106 have round cross-sections. Those skilled in the art will readily appreciate the number of different ways in which shaft adapter 702 and shaft member 106 may be joined.

Other such rotation-inhibiting structures and arrangements also are possible without departing from the invention. For example, either one or both of the shaft adapter 702 and/or the shaft member 106 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention.

Looking briefly to FIG. 9 (which will be discussed in more detail below), the shaft adapter 702 is configured to securely attach to the shaft member 106. The exemplary shaft adapter 702 may be hollow and may be sized to receive a free end portion of a golf club shaft, such as shaft member 106. Thus, in some example structures, the connection of the shaft adapter 702 to a shaft member 106, may be releasable, so as to allow shafts to be easily and quickly switched. Yet, in other structures, the shaft adapter 702 may be integral to or otherwise permanently affixed to the shaft member 106.

As further illustrated in FIGS. 7 and 9, the exterior surface of the shaft adapter 702 at the second end 706 may have a cross-sectional shape that is defined by splines extending along the shaft adapter's axis 708. The splines may create ridges along the surface that are sized to mate and engage in a fixed position with splines of another surface, such as the interior of the head adapter 802 depicted in FIG. 8. The splines may consist of ridges in the surface of the material comprising the shaft adapter 702 and may be machined according to a variety of known techniques, e.g., by extrusion, molding, casting, or any other known manufacturing techniques familiar to those skilled in the art. According to the structure depicted in FIG. 7, the splines may extend up to flange 714. Also, in the example structure depicted, flange 714 is adapted to rest on top 816 of the head adapter 802 depicted in FIG. 8 (the head adapter 802 of FIG. 8 is described in more detail below). Thus, the cross-sectional shape of the exterior surface of the shaft adapter 702 is configured to have a size and shape adapted to fit into the head adapter 802 (as described below) and inhibit rotation of the shaft adapter 702 with respect to the head adapter 802.

According to aspects of the invention described herein, the splines 716, 820 and 906 (each of which is further described below) may consist of alternating ridges and grooves which are triangular, rounded, squared off, or generally trapezoidal in shape. The splines 716 (or polygonal cross-sectional area) may extend along any portion of the longitudinal length of the exterior surface of the shaft adapter 702 (or of the head adapter 802 or of the bore of the hosel area 904) without departing from this invention. For example, the splines 716 may extend from 10-100% of the overall longitudinal length of the exterior surface of the shaft adapter 702, and in some example structures, the splines may extend from 15-80% of the overall longitudinal length or even from 20-60% of the overall longitudinal length. The portion of the exterior surface including the splines 716 also may be located at any desired position along the longitudinal length without departing from this invention, such as extending upward from the second end 706, extending from the flange area 714 toward the second end 706, etc. The splines 716 may also extend only partially around the exterior surface of the shaft adapter 702. For example, the exterior surface of the shaft adapter 702 may be defined by bands of splines 716 spaced evenly around the exterior surface that extend along the longitudinal length or along axis 708 of the shaft adapter 702.

In some example structures, the exterior surface of the shaft adapter 702, the shaft member 106 and/or the head adapter 802, at the locations of the noncircular cross-sections, may be tapered in the axial direction such that the diameter of the component decreases somewhat from the first end to the second end. This feature can assist in making the shaft adapter 702 easily fit into and slide out of the head adapter 802 and/or avoid the need to maintain extremely strict tolerances in the manufacturing process.

2. Exemplary Head Adapter

The exemplary connection of FIG. 9 may further include a head adapter 802 according to additional examples of the invention. The head adapter 802 may be made from one or more suitable materials as described above and may comprise materials that are different than the materials comprising the remaining sections of the golf club. For example, the head adapter 802 may be constructed from a lightweight metal, metal alloy, or polymeric material (e.g., a rigid polymeric material). Looking to FIG. 8, the head adapter 802 has a first end 804 and a second end 806. As seen, the first end 804 is along the same axis (not shown) as the second end 806. The head adapter 802 further comprises a bore 810 along a second axis 812 configured to receive the shaft adapter 702 on the second axis 812 (in turn the shaft adapter 702 receives shaft member 106). Thus, the exterior of the head adapter 802 may extend in one axial direction from the first end 804 to the second end 806, while the bore 810 that receives the shaft adapter 702 extends in a different axial direction (axis 812). Those skilled in the art will readily appreciate upon review of this disclosure that there are various combinations of structural elements and/or processes that may be used to implement the two axes of head adapter 802 without departing from the scope of the invention. The angular difference between the first axis (not shown) and the second axis 812, may be any angle without departing from this invention, e.g., at least 0.25 degrees, at least 0.5 degrees, at least 1 degree, at least 2 degrees, at least 2.5 degrees, at least 4 degrees, or even at least 8 degrees.

The bore 810 of the head adapter 802 may have a cross-sectional shape defined by splines 820 extending along the vertical axis 812, which are shaped to receive and engage with splines 716 on the exterior of shaft adapter 702 in a fixed position. The splines may consist of ridges in the surface of the material comprising the head adapter 802 and may be machined according to a variety of known techniques, e.g., by extrusion, molding, casting, or any other known manufacturing techniques familiar to those skilled in the art. The cross-sectional shape of the bore 810 may thus be configured to have a size and shape adapted to inhibit rotation of the shaft adapter 702 with respect to the head adapter 802. In other example structures, only a portion of the bore 810 engages or mates with the shaft adapter 702, however, the mating or other engagement prevents rotation of the shaft adapter 702 within the head adapter 802. In the specific example structure depicted in FIGS. 8 and 9, the first end 804 of head adapter 802 may be defined by a slight impression 816 that is shaped to receive flange 714 of shaft adapter 702, when shaft adapter 702 is fitted in bore 810 of head adapter 802.

Other rotation-inhibiting structures and arrangements are also possible without departing from this invention. For example, either or both of the head adapter 802 or the shaft adapter 702 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention.

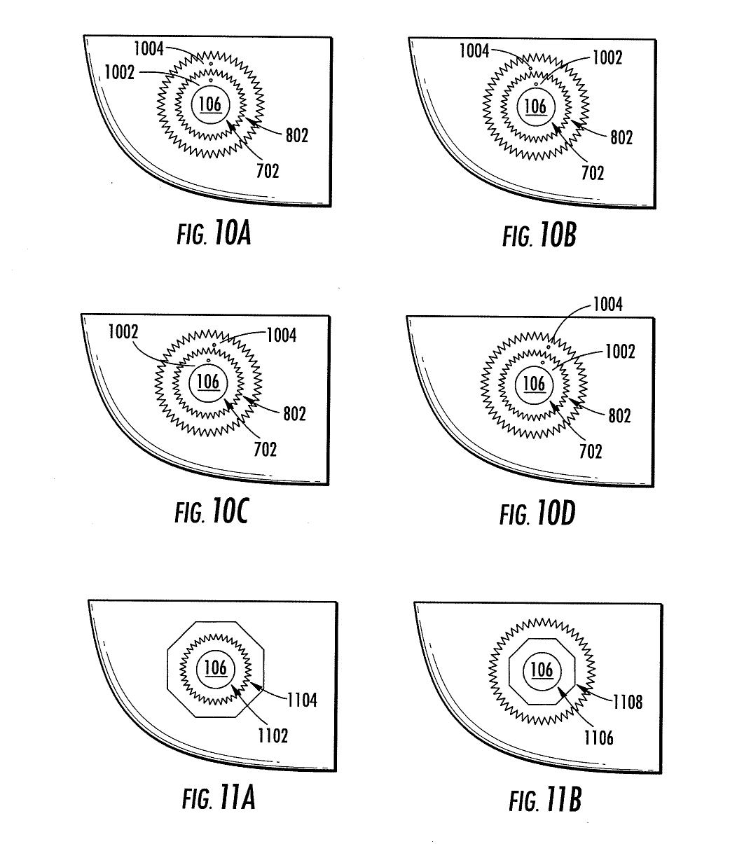

As shown in FIG. 8, the shaft adapter 702 may be configured to fit only partially within the head adapter 802. Yet, in other structures, the shaft adapter 702 may extend more or less than the axial length of the head adapter 802. As discussed further below in relation to FIGS. 10A, 10B, 10C and 10D, the configuration of the shaft adapter 702 and its arrangement with respect to the club head body may be utilized to adjust various positions and/or angles of the ball striking surface of the golf club head 102 (e.g., lie angle, loft angle, face angle, etc.).

In other example structures in accordance with this invention, the head adapter 802 may be integral to or otherwise permanently affixed to a club head 902, such as being received within or integrally formed as part of hosel area 904. In such structures, there may be no exterior surface of the head adapter 802 (although the hosel bore may extend in an “off-axis” manner from the hosel exterior surface, if an exterior hosel is present in the club head structure).

3. Methods of Assembling Alternative Example Structures According to this Invention

FIG. 9 depicts an exploded perspective view of an exemplary golf club 900 according to an example of the invention as depicted and described above for FIGS. 7 and 8. The exploded view of golf club 900 also highlights one of the several methods that may be used for constructing golf clubs according to certain aspects of the invention. According to one exemplary method, the shaft member 106 is attached to the shaft adapter 702 having a first end 704 and a second end 706 along a first axis 708, wherein the shaft member 106 is inserted within a bore 710 extending along a second axis 712 (axis 712 is shown in FIG. 7). The shaft member 106 may be permanently fixed to the shaft adapter 702 (e.g., via cements or adhesives, via fusing techniques (e.g., welding, soldering, or brazing), etc.) or these parts 106 and 702 may be releasably connected to one another. The method may further comprise inserting the second end 706 of the shaft adapter 702 within a bore 810 of a head adapter 802, wherein the head adapter 802 comprises a first end 804 and a second end 806 along a first axis 808 and wherein the bore 810 has a cross-sectional shape defined by splines 820 and is shaped to receive the splines 716 of the second end 706 of the shaft adapter 702 in a plurality of different orientations. The method may further comprise inserting the head adapter 802 into a hosel area 904 of a club head 902. The hosel area 904 may have an internal opening with a cross-sectional shape defined by splines 906 that are shaped to receive the splines 818 of the second end 806 of the head adapter 802 in a plurality of different orientations. According to select structures, the insertion of the head adapter 802 into the hosel area 904 may be selected from a plurality of different orientations, for example, as discussed below in relation to FIGS. 10A-10D. Accordingly, further methods according to this invention may include: removing the shaft adapter 702 from the head adapter 802 and reinserting the second end 706 of the shaft adapter 702 into the bore 810 of the head adapter 802 in a different orientation (e.g., at a different rotational position); and/or removing the head adapter 802 from the hosel area 904 of the club head 902 and reinserting the head adapter 802 into the hosel area 904 of the club head 902 in a different orientation (e.g., at a different rotational position).

Exemplary hosel area 904 may comprise an interior chamber or bore for receiving the head adapter 802. The bore may be machined into the golf club head 902 during manufacturing of the head according to machining techniques known to those skilled in the art. In one example structure, the hosel area 904 is created by drilling or otherwise excavating a portion of golf club head 902. In this regard, at least a portion of the outer perimeter of the hosel area 904 comprises the same materials as the golf club head 902. Further, the shape of the bore may be defined by splines so as to engageably receive head adapter 802 that has an exterior shape defined by splines. The shaft member 106 may be secured to the club head 902 (through the shaft adapter 702 and the head adapter 802) in any desired manner, including releasable connection systems that are known and used in the art. As seen in the exploded view of FIG. 9, an exterior portion of the hosel area 904 may have threads 910. Threads 910 may be used to secure the entire interconnection assembly by engaging threaded nut 908 over the first end 704 of the shaft adapter with threads 910 on the exterior surface of the hosel area 904. As another example, a threaded bolt may extend through an opening provided in the club head (e.g., in the club head sole) that engages a threaded portion provided in the bottom of the shaft member 106, the shaft adapter 702, and/or the head adapter 802.

4. Adjusting the Head Adapter and the Shaft Adapter

Because the axis of the bore 710 in the shaft adapter 702 may be offset from the axis of the exterior surface of the shaft adapter 702, and because the axis of the bore in the head adapter 802 may be offset from the axis of its exterior surface, rotation of either of these adapters with respect to the club head 902 will change the position of the shaft member 106 with respect to the ball striking face of the club head. The offsets may be an angle within the range of 0.25 to 4 degrees, and in some examples, the offset may be by an angle within the range of 0.5 to 2 degrees. FIGS. 10A-10D each show a top view of a portion of a golf club according to alternative example structures of the invention where both the shaft adapter 702 and head adapter 802 may be placed in different rotational orientations in relation to club head 902. In contrast to the rotation of the structures depicted in FIGS. 5A-5B wherein the rotation must equal at least one full side of the polygon, the alternative structures depicted in FIGS. 7-9 allow for smaller, more incremental rotations. Specifically, looking to FIG. 10A, shaft member 106 is securely retained within shaft adapter 702. As seen in FIGS. 10A-10D, shaft adapter 702 has an outer exterior shape defined by splines extending along the axis 708 of shaft adapter 702. The exterior surface of shaft adapter 702 engages and mates with the head adapter 802, having an inner perimeter bore shape defined by splines extending along the axis 812 of head adapter 802, for receiving the shaft adapter 702. In FIGS. 10A-10D, the exterior surface of shaft adapter 702 and the bore of head adapter 802 are similarly shaped, such that the splines of head adapter 802 receive and engage the splines of shaft adapter 702 in a number of different rotational orientations in relation to one another, but also in such a way as to inhibit rotation and movement.

The exemplary shaft adapter 702 of FIGS. 10A-10D may include indicia 1002 and the exemplary head adapter 802 may include indicia 1004. Indicia 1002 on shaft adapter 702 indicates the rotational position of the shaft adapter 702 with respect to the head adapter 802, and subsequently the club head 902. Indicia 1004 on head adapter 802 indicates the rotational position of the head adapter 802 in relation to the club head 902 and also the shaft adapter 702. The indicia 1002, 1004 are advantageous to allow users to better record the club head/shaft orientation and/or to allow a reliable return to a previous position after rotation of one or more of the components in relation to the shaft member 106 has taken place. Because both the exemplary shaft adapter 702 and the head adapter 802 are shaped as defined by splines 716, 818 and 820, there are a large number of rotational orientations where they may engage and securely mate in a releasable manner. Therefore, the following discussion will refer to the positions of the head adapter 702 and the shaft adapter 802 as being in incremental rotational positions. Position 1 refers to when the indicia 1002, 1004 are at the 12 o'clock position in FIG. 10A and the subsequent positions are described as incremental rotations in a clockwise fashion. In yet further examples, if desired, club head 902 may be marked with indicia.

Depending on how the shaft adapter 702 and/or the head adapter 802 are positioned in relation to the “face” of the club head 102, the playing characteristics of the club may be modified. This feature, along with the releasable connection system 104, allows club fitters (or others) to freely and easily adjust various angles and/or positions of the shaft member 106 with respect to the club head 102 (e.g., variable lie, loft, and face angle combinations) while still using the same shaft 106 and/or head 102, which can help users more easily determine the optimum club head/shaft combination and arrangement to suit their needs. Looking to FIG. 10A, indicia 1002 indicates that the shaft adapter 702 is in position 1, and indicia 1004 indicates that the head adapter 802 is also in position 1. As seen in FIG. 10B, the shaft adapter 702 (and thus the shaft 106) has been incrementally rotated in a clockwise direction, while the head adapter 802 remains in position 1. In FIG. 10C, on the other hand, the head adapter 802 (and thus the club head 102) has been incrementally rotated in a clockwise direction, while the shaft adapter 702 remains in position 1. In FIG. 10D, both the shaft adapter 702 and the head adapter 802 have been incrementally rotated in a clockwise direction, effectually rotating both the shaft 106 and the club head 102 with respect to one another.

Repositioning the shaft adapter 702 in relation to the head adapter 802 as described may be advantageous to adjust the club head/shaft orientation by a known factor. For example, information may be associated with the shaft adapter 702 and the head adapter 802 relating to the angle of the offset-axes of the bores 710, 810. The information may be provided with the adapters 702 and 802, may be printed, engraved, or otherwise marked on the adapters 702 and 802, themselves, or may otherwise be made available. Those skilled in the art will recognize that FIGS. 10A-10D represent only four configurations of a large number of rotational orientations where the shaft adapter 702 and the head adapter 802 may engage and securely mate in a releasable manner.

FIGS. 11A and 11B depict top views of a portion of a club head according to still further examples of the invention described herein. FIG. 11A depicts a head adapter 1104 that has an exterior cross-sectional shape of a regular polygon and interior bore with a cross-sectional shape defined by splines extending along the vertical axis of head adapter 1104. Shaft adapter 1102 depicted in FIG. 11A has an exterior cross-sectional shape defined by splines extending along the vertical axis of shaft adapter 1102, and is shaped to be received by, and engage with, the vertical splines on the interior bore of head adapter 1104. FIG. 11B, shows a configuration similar to FIG. 11A, but FIG. 11B depicts a head adapter 1108 that has an exterior cross-sectional shape defined by splines extending along the vertical axis of head adapter 1108 and an interior bore with a cross-sectional shape of a regular polygon. Shaft adapter 1106 depicted in FIG. 11B has an exterior cross-sectional shape of a regular polygon, and is shaped to be received by, and engage with, the regular polygon shape of the interior bore of head adapter 1108. The further embodiments depicted in FIGS. 11A and 11B reflect only two of many different combinations of embodiments that fall within the scope of the invention, and that would be recognized as such by those skilled in the art. As a more specific example, any desired polygonal cross-sectional shapes may be used without departing from this invention, such as a 3 to 20 sided polygon.

### F. ADDITIONAL EXEMPLARY STRUCTURES OF THE INVENTION

Aspects of the invention described herein may be further defined by the following additional example structures. The following example structures are described in reference to the exemplary club structure described above and depicted in FIG. 1.

1. Exemplary Shaft Adapter/Head Adapter Assembly with Bottom-Fed Head Adapter

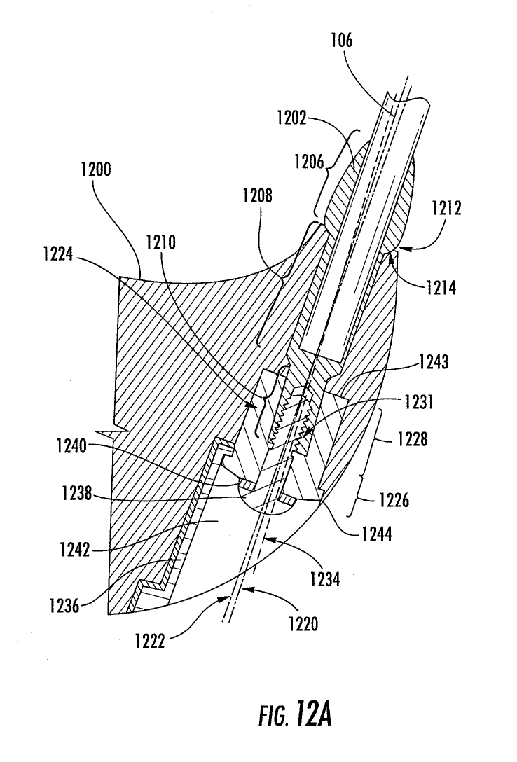

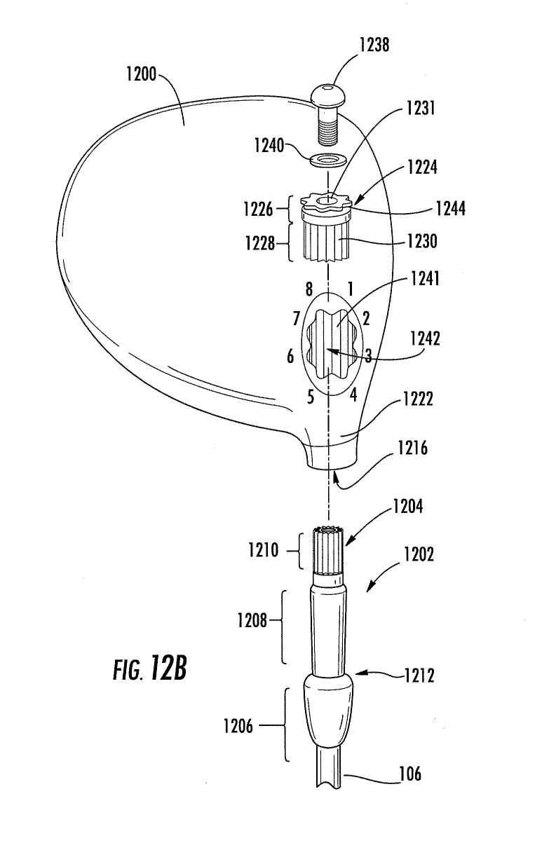

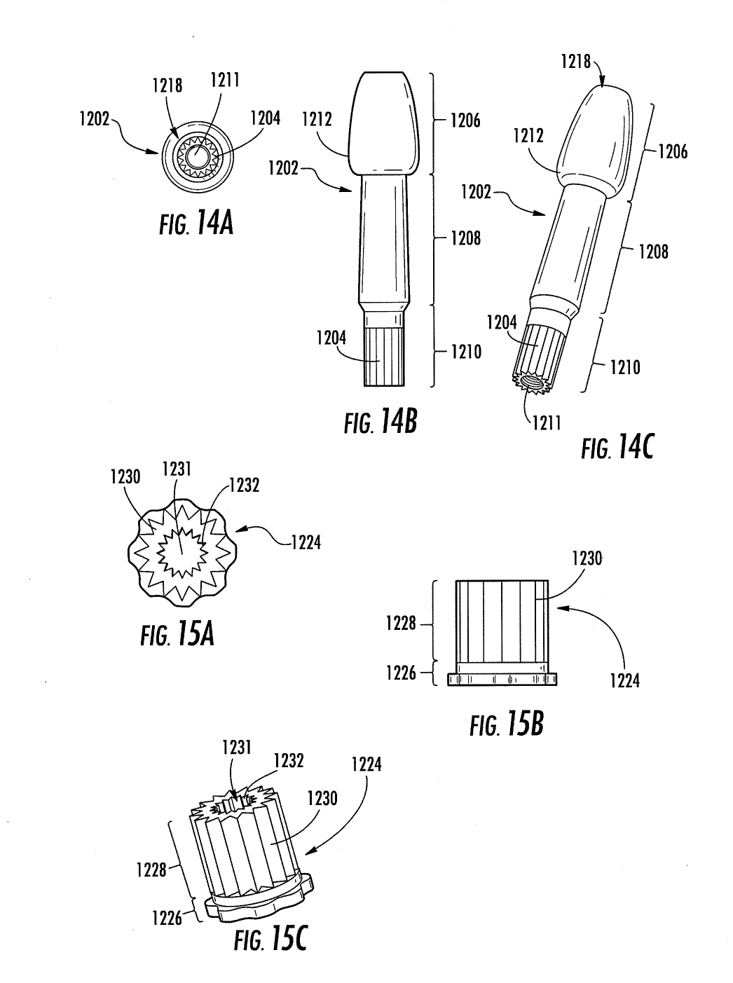

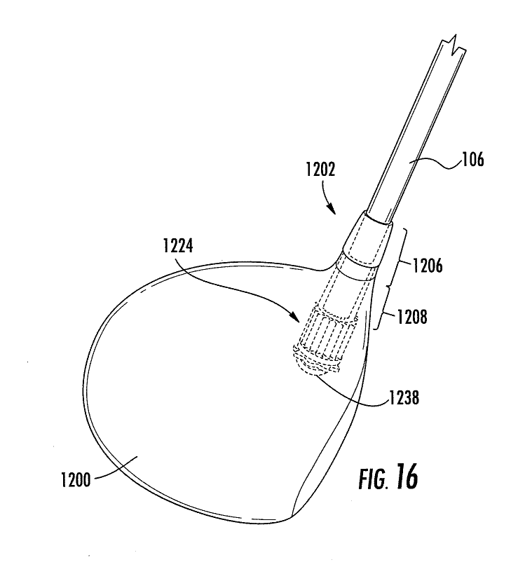

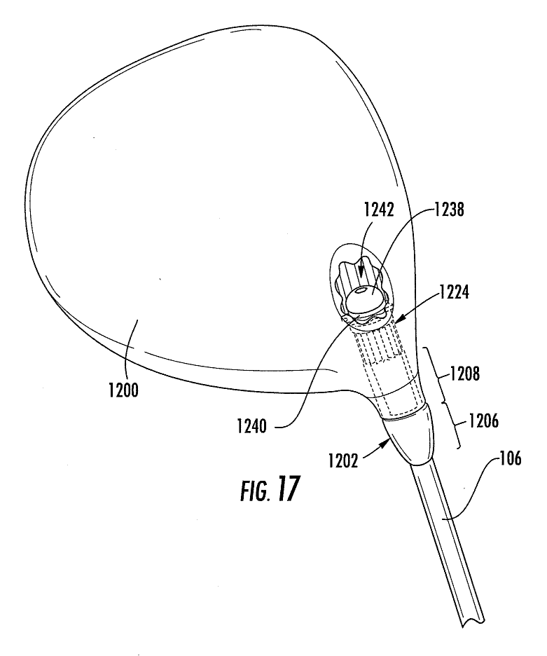

FIGS. 12A, 12B, and 14A through 17 illustrate an adjustable shaft adapter/head adapter assembly according to another example structure of the invention. FIG. 12A is a cross-sectional perspective view of an example shaft adapter 1202 and head adapter 1224 according to the example of the invention. FIG. 12B is an exploded view of the shaft adapter/head adapter assembly depicted in FIG. 12A. FIGS. 14A through 14C are detailed views of the shaft adapter 1202 according to this example of the invention. FIGS. 15A through 15C are detailed views of the head adapter 1224 according to this example of the invention. FIG. 16 is a top perspective view of the shaft adapter/head adapter assembly installed in a club head according to this example of the invention. FIG. 17 is a bottom perspective view of the shaft adapter/head adapter assembly installed in a club head according to this example of the invention.

The example shaft adapter 1202 is similar to exemplary shaft adapter 702 described above in that the exterior surface of the shaft adapter 1202 may be fully or partially defined by splines 1204 (depicted in FIGS. 12B, 14B, and 14C) extending along a portion of the longitudinal axis of the shaft adapter 1202. The shaft adapter 1202 may be made from one or more suitable materials as described above and may comprise materials that are different than the materials comprising the remaining sections of the golf club. For example, the shaft adapter 1202 may be constructed from a lightweight metal, metal alloy, or polymeric material (e.g., a rigid polymeric material).

The shaft adapter 1202 is generally cylindrically shaped and has a first end 1206, a middle portion 1208 and a second end 1210 along the same axis. According to the example structure depicted in FIGS. 12A, 12B, and 14A through 14C, the first end 1206, the middle portion 1208 and the second end 1210 may exhibit decreasing diameters, respectively. The first end 1206 may comprise a lip 1212 that is adapted to rest upon a bearing area 1214 of the hosel area 1216. Shaft adapter 1202 further comprises a bore 1218 configured to attach to a shaft member 106 along an offset axis 1220. The offset axis 1220 may be offset from a central hosel axis 1222 by about 2 degrees, however the offset angle may be any angle without departing from this invention, e.g., at least 0.25 degrees, at least 0.5 degrees, at least 1 degree, at least 2 degrees, at least 2.5 degrees, at least 4 degrees, or even at least 8 degrees.

Additionally, the second end 1210 may include a securing structure (e.g., a threaded hole 1211 in this example structure) that assists in securely engaging the shaft adapter 1202 to a club head body as will be explained in more detail below. In this example structure, as shown in FIGS. 12A, 14A, and 14C, the bore 1218 is not open to the threaded hole 1211, but if desired, the threaded hole 1211 may extend to and open in to the interior chamber 1218 in some structures in accordance with this invention.

According to the example structure shown in FIGS. 12A, 12B, and 14A through 14C, the bore 1218 may have a circular cross-sectional shape, e.g., to receive a conventionally-shaped round shaft. If desired, however, the cross-sectional shape of the bore 1218 may be configured to have a size and shape adapted to inhibit rotation of the shaft member 106 with respect to the shaft adapter 1202. For example, the shape of the bore 1218 itself may be defined by splines that are shaped to receive and engage a shaft member with a partially splined exterior. As described above with respect to shaft adapter 202, shaft adapter 1202 may be configured in a number of ways such that bore 1218 engages or mates with the shaft member 106, and such that the mating prevents rotation of the shaft adapter 1202 within the shaft member 106. In still other structures, the shaft adapter 1202 may be permanently engaged with the shaft member 106 (for example, via cements or adhesives; via welding, brazing, soldering, or other fusing techniques; via mechanical connectors; via a friction fit; etc.) particularly in example structures in which the bore 1218 and the shaft member 106 have round cross-sections. Those skilled in the art will readily appreciate the number of different ways in which shaft adapter 1202 and shaft member 106 may be joined.

Other such rotation-inhibiting structures and arrangements, with respect to receipt of shaft 106 within shaft adapter 1202, are also possible without departing from the invention. For example, either one or both of the shaft adapter 1202 and/or the shaft member 106 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention. Thus, in some example structures, the connection of the shaft adapter 1202 to a shaft member 106, may be releasable, so as to allow shafts to be easily and quickly switched. Yet, in other structures, the shaft adapter 1202 may be integral to or otherwise permanently affixed to the shaft member 106.

As illustrated in FIGS. 12A, 12B, and 14A through 14C, the exterior surface of the shaft adapter 1202 may have a cross-sectional shape that is fully or partially defined by splines 1204 extending along the shaft adapter's axis 1220. The splines 1204 may create ridges along the surface that are sized to mate and engage in a fixed position with splines of another surface, such as the splines 1232 in the interior of the head adapter 1224. The splines 1204 may consist of ridges in the surface of the material comprising the shaft adapter 1202 and may be machined according to a variety of known techniques, e.g., by extrusion, molding, casting, or any other known manufacturing techniques familiar to those skilled in the art. According to the example structure depicted in FIG. 12B, the splines 1204 may extend along second end 1210 of the shaft adapter 1202. Thus, the cross-sectional shape of the exterior surface of the shaft adapter 1202 is configured to have a size and shape adapted to fit into the hosel area 1216 (shown in FIG. 12B) and the head adapter 1224 (inserted in the bottom of club head 1200, as described below) and inhibit rotation of the shaft adapter 1202 with respect to the head adapter 1224.

According to aspects of the invention described herein, splines 1204, the splines 1241 within the bottom of the interior chamber 1242 and the splines 1230 and 1232 (each of which is further described below) may consist of alternating ridges and grooves which are triangular, rounded, squared off, or generally trapezoidal in shape. The splines 1204 (or polygonal cross-sectional area) may extend along any portion of the longitudinal length of the exterior surface of the shaft adapter 1202 (or of the head adapter 1224 or of the bore of the hosel area 1216) without departing from this invention. For example, the splines 1204 may extend from 10-100% of the overall longitudinal length of the exterior surface of the shaft adapter 1202, and in some example structures, the splines may extend from 15-80% of the overall longitudinal length or even from 20-60% of the overall longitudinal length. The portion of the exterior surface including the splines 1204 also may be located at any desired position along the longitudinal length without departing from this invention, such as extending upward from the second end 1210, extending from the lip area 1212 toward the second end 1210, etc. The splines 1204 may also extend only partially around the exterior surface of the shaft adapter 1202. For example, the exterior surface of the shaft adapter 1202 may be defined by bands of splines spaced evenly around the exterior surface that extend along the longitudinal length or along axis 1220 of the shaft adapter 1202. In addition, the splined areas 1204, 1241, 1230 and 1232 may instead have the cross-sectional shape of a regular polygon with anywhere from 3 up to 20 sides without departing from this invention.

In some example structures, the exterior surface of the shaft adapter 1202, the shaft member 106 and/or the head adapter 1224, at the locations of the noncircular cross-sections, may be tapered in the axial direction such that the diameter of the component decreases somewhat across the first end 1206, across the middle portion 1208, and across the second end 1210. This feature can assist in making the shaft adapter 1202 easily fit into and slide out of the head adapter 1224 and/or avoid the need to maintain extremely strict tolerances in the manufacturing process.

Exemplary connection 104 may further include a head adapter 1224 according to the additional example of the invention depicted in FIGS. 12A, 12B, and 15A through 15C. The head adapter 1224 may be made from one or more suitable materials as described above and may comprise materials that are different than the materials comprising the remaining sections of the golf club. For example, the head adapter 1224 may be constructed from a lightweight metal, metal alloy, or polymeric material (e.g., a rigid polymeric material). Looking at FIGS. 12A, 12B, and 15A through 15C, the exemplary head adapter 1224 has a first end 1226 and a second end 1228. As seen, the first end 1226 is along the same axis (shown as axis 1220 in FIG. 12A) as the second end 1228. The head adapter 1224 further comprises a bore 1231 along a second axis 1234 configured to receive the shaft adapter 1202 on the second axis 1234 (in turn the shaft adapter 1202 receives shaft member 106). Thus, the exterior of the head adapter 1224 may extend in one axial direction from the first end 1226 to the second end 1228 (axis 1220), while the bore 1231 that receives the shaft adapter 1202 extends in a different axial direction (axis 1234). Those skilled in the art will readily appreciate upon review of this disclosure that there are various combinations of structural elements and/or processes that may be used to implement the two axes of head adapter 1224 without departing from the scope of the invention. The angular difference between the first axis 1220 and the second axis 1234, may be any angle without departing from this invention, e.g., at least 0.25 degrees, at least 0.5 degrees, at least 1 degree, at least 2 degrees, at least 2.5 degrees, at least 4 degrees, or even at least 8 degrees.

The bore 1231 of the head adapter 1224 may also have a cross-sectional shape defined by splines 1232 extending longitudinally within the bore 1231, which are shaped to receive and engage with splines 1204 on the exterior of shaft adapter 1202 in a fixed position. The splines 1232 may consist of ridges in the surface of the material comprising the head adapter 1224 and may be machined according to a variety of known techniques, e.g., by extrusion, molding, casting, or any other known manufacturing techniques familiar to those skilled in the art. The cross-sectional shape of the bore 1231 may thus be configured to have a size and shape adapted to inhibit rotation of the shaft adapter 1202 with respect to the head adapter 1224. According to the cross-sectional view, FIG. 12A, only a portion of the bore 1231 engages or mates with the shaft adapter 1202. In other embodiments, the head adapter 1224 may be sized such that the shaft adapter is received within the full length of the head adapter 1224.

In the specific example structure depicted in FIGS. 12A and 12B, club head 1200 may have an interior chamber 1242 defined in the bottom of the club head 1200 that provides an opening along the axis 1220 for receiving the head adapter 1224. As seen in FIG. 12A, the head adapter 1224 is adapted for insertion in the interior chamber 1242 such that the second end 1228 of the head adapter 1224 receives and engages with, in a rotation-inhibiting fashion, the second end 1210 of the shaft adapter 1202 in the hosel area 1216 of club head 1200. The interior chamber 1242 may be defined by insert interface 1236 as shown in FIG. 12A. According to the example structure shown in FIG. 12A, head adapter 1224 further comprises a flange 1244 that may rest upon insert interface 1236. The exterior surface of the head adapter 1224 may also be defined by splines 1230, which may be configured to be received by, and engage with in a rotation-inhibiting manner, the splines 1241 in the bottom of the interior chamber 1242.

The shaft adapter 1202/head adapter 1224 assembly may be secured to the club head by washer 1240 and bolt 1238 as depicted. Those skilled in the art will recognize that there are a variety of ways to secure the implements of FIGS. 12A and 12B. For instance, instead of bolt 1238, the head adapter 1224 may be permanently fixed in the interior chamber 1242 of the hosel area by known techniques.

Other rotation-inhibiting structures and arrangements are also possible without departing from this invention. For example, either or both of the head adapter 1224 or the shaft adapter 1202 may include mechanical structures, such as spring loaded pins or other extending structures that extend into openings, slots, or ridges (e.g., akin to attachment of hydraulic hoses to their hydraulic oil supply connection elements). Detent mechanisms and other physical (and optionally static) securing structures that fit into openings, slots, or ridges also may be used as a releasable rotation-inhibiting connection without departing from this invention.

As shown in FIG. 12A, the shaft adapter 1202 may be configured to fit only partially within the head adapter 1224. Yet, in other structures, the shaft adapter 1202 may extend more or less than the axial length of the head adapter 1224. In further example structures in accordance with this invention, the head adapter 1224 may be integral to or otherwise permanently affixed to a club head 1200, such as being received within or integrally formed as part of hosel area 1236. In such structures, there may be no exterior surface of the head adapter 1224 (although the hosel bore may extend in an “off-axis” manner from the hosel exterior surface, if an exterior hosel is present in the club head structure).

The exploded view of the shaft adapter 1202/head adapter 1224 assembly of FIG. 12B further highlights one of the several methods that may be used for constructing golf clubs according to certain aspects of the invention. According to the exemplary method, the shaft member 106 is attached to the shaft adapter 1202, wherein the shaft member 106 is inserted within a bore 1218 extending along a second axis 1220. The method may further comprise inserting the second end 1210 of the shaft adapter 1202 within a bore 1231 of a head adapter 1224, wherein the bore 1231 has a cross-sectional shape defined by splines 1232 and is shaped to receive and engage with splines 1204 of the second end 1210 of the shaft adapter 1202 in a plurality of different orientations. The method may further comprise inserting the head adapter 1224 into the bottom of club head 1200 in area 1242 defined by insert 1236. This bottom portion of hosel area 1216 or the bottom of the interior chamber 1242 may have an internal opening with a cross-sectional shape defined by splines 1241 that are shaped to receive the splines 1230 of the second end 1228 of the head adapter 1224 in a plurality of different orientations. According to select structures, the insertion of the head adapter 1224 into the hosel area defined on the bottom of the club head 1236 may be selected from a plurality of different orientations, for example, as noted at 1236 of FIG. 12B, indicia 1-8. Accordingly, further methods according to this invention may include: removing the shaft adapter 1202 from the head adapter 1224 and reinserting the second end 1210 of the shaft adapter 1202 into the bore 1231 of the head adapter 1224 in a different orientation (e.g., at a different rotational position); and/or removing the head adapter 1224 from the bottom of the hosel area, 1236, and reinserting the head adapter 1224 into the bottom of the hosel area 1236 of the club head 1200 in a different orientation.

Once inserted, the shaft adapter 1202 and the head adapter 1224 may be secured with the club head 1200 by inserting the securing system 1238 through the interior chamber 1242 in the sole of the club head 1200 and engaging the securing system 1238 with the securing structure 1211 provided within the shaft adapter 1202. If desired, the locations where the head adapter 1224 meet the club head 1200 (e.g., at mounting ridge 1243 and/or the hosel opening) and/or where the securing system 1238 meets the club head 1200 may include a flexible material (such as a washer, a gasket, an o-ring, an elastomeric washer or coating, etc.) to provide noise and/or vibration dampening, etc. This illustrated connection system is readily releasable, e.g., by twisting out the bolt member 1238. If desired, the bolt 1238 and the interior chamber 1242 may be structured so as to prevent the bolt 1238 from completely falling out of the interior chamber 1242 when the bolt 1238 is released from the shaft adapter 1202 (e.g., by providing an enlarged ring on the free end of bolt 1238). The bolt 1238 may include a head having structures for engaging a screwdriver, an alien wrench, or another tool.

Because the axis of the bore 1218 in the shaft adapter 1202 may be offset from the axis of the exterior surface of the shaft adapter 1202, and because the axis of the bore 1231 in the head adapter 1224 may be offset from the axis of its exterior surface, rotation of either of these adapters with respect to the club head 1200 will change the position of the shaft member 106 with respect to the ball striking face of the club head. As described in more detail above with respect to previous example structures, this feature, along with the releasable connection system 104, allows club fitters (or others) to freely and easily adjust various angles and/or positions of the shaft member 106 with respect to the club head 102 (e.g., variable lie, loft, and face angle combinations) while still using the same shaft 106 and/or head 102, which can help users more easily determine the optimum club head/shaft combination and arrangement to suit their needs.

2. Additional Exemplary Shaft Adapter/Head Adapter Assembly

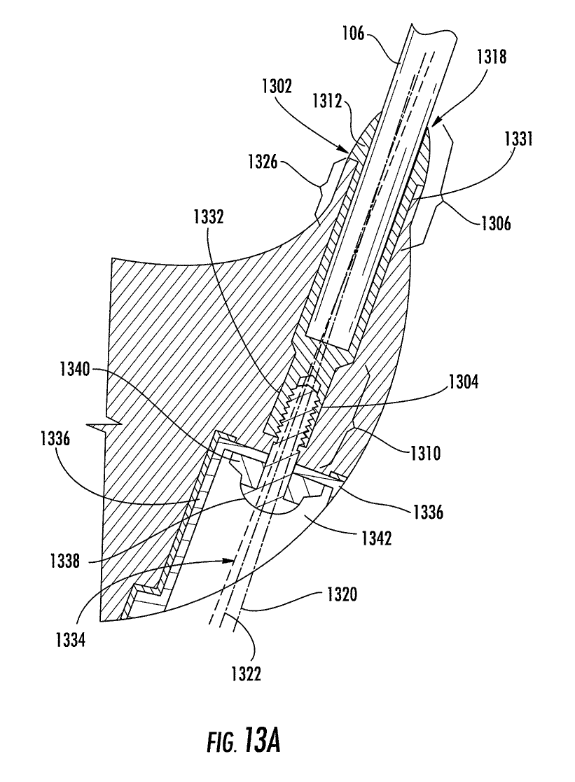

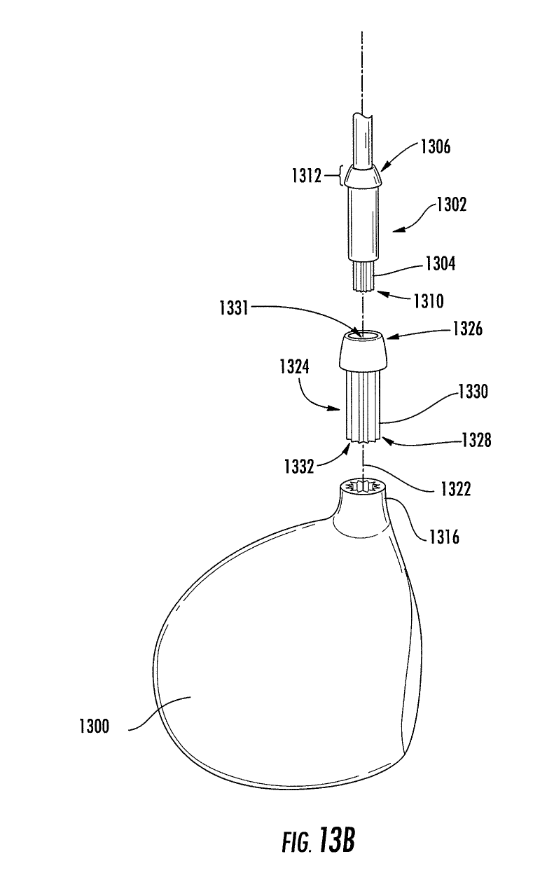

FIGS. 13A and 13B illustrate an adjustable shaft adapter/head adapter assembly according to yet another example structure of the invention. The shaft adapter/head adapter assembly depicted in the cross-sectional view of FIG. 13A and the exploded view of FIG. 13B is similar to the exemplary structures depicted in FIGS. 7-9 and FIGS. 12A-12B. Thus, the discussion will be made with reference to the exemplary structures of FIGS. 7-9 and FIGS. 12A-12B.

The example shaft adapter 1302 is similar to exemplary shaft adapters 702 and 1202 described above in that the exterior surface of the shaft adapter 1302 may be fully or partially defined by splines 1304 (depicted in FIG. 13B) extending along the longitudinal axis of the shaft adapter 1302. The shaft adapter 1302 may be made from one or more suitable materials as described above and may comprise materials that are different than the materials comprising the remaining sections of the golf club. For example, the shaft adapter 1302 may be constructed from a lightweight metal, metal alloy, or polymeric material (e.g., a rigid polymeric material).

Shaft adapter 1302 is generally cylindrically shaped and has a first end 1306 and a second end 1310 along the same axis. According to the example structure depicted in FIGS. 13A and 13B, shaft adapter 1302 may decrease in diameter from the first end 1306 to the second end 1310. Referring to FIG. 13B, the first end 1306 may comprise an outward-projecting area 1312 that is adapted to rest upon and mate with a first end 1326 of a head adapter 1324. Shaft adapter 1302 further comprises a bore 1318 configured to attach to a shaft member 106 along an offset axis 1320. The offset axis 1320 may be offset from a central hosel axis 1322 by about 2 degrees, however the offset angle may be any angle without departing from this invention, e.g., at least 0.25 degrees, at least 0.5 degrees, at least 1 degree, at least 2 degrees, at least 2.5 degrees, at least 4 degrees, or even at least 8 degrees.

According to the example structure shown in FIGS. 13A and 13B the bore 1318 may have a circular cross-sectional shape, e.g., to receive a conventionally-shaped round shaft. As described above with respect to shaft adapter 202 and shaft adapter 1202, shaft adapter 1302 may be configured in a number of ways such that bore 1318 engages or mates with the shaft member 106, and such that the mating prevents rotation of the shaft adapter 1302 within the shaft member 106. Those skilled in the art will readily appreciate the number of different ways in which shaft adapter 1302 and shaft member 106 may be joined.

As illustrated in FIGS. 13A and 13B, the exterior surface of the shaft adapter 1302 may have a cross-sectional shape that is fully or partially defined by splines 1304 extending along the shaft adapter's axis 1320. The splines may create ridges along the surface that are sized to mate and engage in a fixed position with splines of another surface, such as the interior of the head adapter 1324. The splines as referred to with respect to FIGS. 13A and 13B may be sized, shaped and machined as previously described. According to the example structure depicted in FIG. 13B, the splines 1304 may extend along second end 1310 of the shaft adapter 1302. Thus, the cross-sectional shape of the exterior surface of the shaft adapter 1302 is configured to have a size and shape adapted to fit into the head adapter 1324 and inhibit rotation of the shaft adapter 1302 with respect to the head adapter 1324. The splines 1304 (or, alternatively, a polygonal cross-sectional area) may extend along any portion of the longitudinal length of the exterior surface of the shaft adapter 1302 (or of the head adapter 1324 or of the bore of the hosel area 1316) without departing from this invention, as previously discussed with respect to exemplary structures of FIGS. 7-9 and FIGS. 12A-12B. In addition, the areas 1304, 1330 and 1332 may instead have the cross-sectional shape of a regular polygon with anywhere from 3 up to 20 sides without departing from this invention.

In some example structures, the exterior surface of the shaft adapter 1302, the shaft member 106 and/or the head adapter 1324, at the locations of the noncircular cross-sections, may be tapered in the axial direction such that the diameter of the component decreases from the first end to the second end of each. This feature can assist in making the shaft adapter 1302 easily fit into and slide out of the head adapter 1324 and/or avoid the need to maintain extremely strict tolerances in the manufacturing process.

The exemplary structure depicted in FIGS. 13A and 13B may further include a head adapter 1324. The head adapter 1324 may be made from one or more suitable materials as described above and may comprise materials that are different than the materials comprising the remaining sections of the golf club, as previously discussed. For example, the head adapter 1324 may be constructed from a lightweight metal, metal alloy, or polymeric material (e.g., a rigid polymeric material). Looking at FIGS. 13A and 13B, the exemplary head adapter 1324 has a first end 1326 and a second end 1328. As seen, the first end 1326 is along the same axis (shown as axis 1320 in FIG. 13A) as the second end 1328. The head adapter 1324 further comprises a bore 1331 along a second axis 1334 configured to receive the shaft adapter 1302 on the second axis 1334 (in turn the shaft adapter 1302 receives shaft member 106). Thus, the exterior of the head adapter 1324 may extend in one axial direction from the first end 1326 to the second end 1328 (axis 1320), while the bore 1331 that receives the shaft adapter 1302 extends in a different axial direction (axis 1334). Those skilled in the art will readily appreciate upon review of this disclosure that there are various combinations of structural elements and/or processes that may be used to implement the two axes of head adapter 1324 without departing from the scope of the invention. The angular difference between the first axis 1320 and the second axis 1334, may be any angle without departing from this invention, e.g., at least 0.25 degrees, at least 0.5 degrees, at least 1 degree, at least 2 degrees, at least 2.5 degrees, at least 4 degrees, or even at least 8 degrees.

The bore 1331 of the head adapter 1324 may have a cross-sectional shape defined at least in part by splines 1332 extending longitudinally within the bore 1331, that are shaped to receive and engage with splines 1304 on the exterior of shaft adapter 1302 in a fixed position. Splines 1332 also may be sized, shaped and machined as previously discussed. The cross-sectional shape of the bore 1331 may thus be configured to have a size and shape adapted to inhibit rotation of the shaft adapter 1302 with respect to the head adapter 1324. According to the cross-sectional view, FIG. 13A, the shaft adapter 1302 may be inserted in, such that it mates with the entire portion of the bore 1331. In other embodiments, the head adapter 1324 may be sized such that the shaft adapter is received within only a portion of the length of the head adapter 1324.

In the specific example structure depicted in FIGS. 13A and 13B, club head 1300 may have a space 1342 defined on the bottom of the club head providing an opening along the axis 1320 for receiving the head adapter 1324. As seen in FIG. 13A, space 1342 may be defined by insert interface 1336. According to the example structure shown in FIG. 13A, the shaft adapter 1302/head adapter 1324 assembly may be secured to the club head by washer 1340 and bolt 1338 from the bottom of the club head 1300 as depicted. However, those skilled in the art will recognize that there are a variety of ways to secure the implements of FIGS. 13A and 13B.

In further example structures in accordance with this invention, the head adapter 1324 may be integral to or otherwise permanently affixed to a club head 1300, such as being received within or integrally formed as part of hosel area 1316. In such structures, there may be no exterior surface of the head adapter 1324 (although the hosel bore may extend in an “off-axis” manner from the hosel exterior surface, if an exterior hosel is present in the club head structure).

The exploded view of the shaft adapter 1302/head adapter 1324 assembly of FIG. 13B further highlights one of the several methods that may be used for constructing golf clubs according to certain aspects of the invention. According to the exemplary method, the shaft member 106 is attached to the shaft adapter 1302, wherein the shaft member 106 is inserted within a bore 1318 extending along a second axis 1320. The method may further comprise inserting the second end 1310 of the shaft adapter 1302 within a bore 1331 of a head adapter 1324, wherein the bore 1331 has a cross-sectional shape defined by splines 1332 and is shaped to receive the splines 1304 of the second end 1310 of the shaft adapter 1302 in a plurality of different orientations. The method may further comprise inserting the head adapter 1324 into a hosel area 1316 of a club head 1300. The hosel area 1316 may have an internal opening with a cross-sectional shape defined by splines that are shaped to receive the splines 1330 of the second end 1328 of the head adapter 1324 in a plurality of different orientations. According to aspects described herein, the head adapter 1324 may be inserted into the hosel area 1316 in a plurality of different orientations, for example, by rotating the head adapter 1324 clockwise or counter-clockwise. Accordingly, further methods according to this invention may include removing the shaft adapter 1302 from the head adapter 1324 and reinserting the second end 1310 of the shaft adapter 1302 into the bore 1331 of the head adapter 1324 in a different orientation (e.g., at a different rotational position).

Because the axis of the bore 1318 in the shaft adapter 1302 may be offset from the axis of the exterior surface of the shaft adapter 1302, and because the axis of the bore 1331 in the head adapter 1324 may be offset from the axis of its exterior surface, rotation of either of these adapters with respect to the club head 1300 will change the position of the shaft member 106 with respect to the ball striking face of the club head. As described in more detail above with respect to previous example structure, this feature, along with the releasable connection system 104, allows club fitters (or others) to freely and easily adjust various angles and/or positions of the shaft member 106 with respect to the club head 102 (e.g., variable lie, loft, and face angle combinations) while still using the same shaft 106 and/or head 102, which can help users more easily determine the optimum club head/shaft combination and arrangement to suit their needs.

The further exemplary structures depicted in FIGS. 12A-12B and 13A-13B reflect only two of many different combinations of embodiments that fall within the scope of the invention, and that would be recognized as such by those skilled in the art. As a more specific example, any surface that is depicted and described as being defined by splines in FIGS. 12A-12B and 13A-13B may also have a polygonal cross-sectional shape, such as a 3 to 20 sided polygon

### CONCLUSION

While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

We claim:

1. A golf club comprising:
a shaft;
a golf club head having a hosel area and an interior chamber defined in a bottom of the club head;
a shaft adapter engaged with the shaft, the shaft adapter having a first end and a second end along a first axis, the shaft adapter further comprising a bore extending along a second axis, wherein one end of the shaft extends into the bore on the second axis, wherein at least a portion of an exterior surface of the shaft adapter has a noncircular cross-sectional shape, the second end including a securing structure;
a head adapter having a first end and a second end along a first axis, the head adapter further comprising a bore having a noncircular cross-sectional shape along a second axis that is shaped to receive and engage the portion of the exterior surface of the shaft adapter having the noncircular cross-sectional shape in a non-rotational manner and in a plurality of different orientations; and
a securing member extending into the second end of the shaft adapter and releasably engaging the securing structure of the shaft adapter to thereby releasably engage the shaft adapter and the head adapter to the golf club head,
wherein the hosel area engages with an exterior surface of the shaft adapter and the interior chamber provides an opening for receiving the head adapter.

2. The golf club of claim 1, wherein the noncircular cross-sectional shape of the exterior surface of the shaft adapter is defined by splines along the first axis and the noncircular cross-sectional shape of the bore of the head adapter is defined by splines along the second axis of the head adapter and is oriented to receive and engage with the splines on the exterior surface of the shaft adapter.

3. The golf club of claim 1, wherein at least a portion of an interior chamber of the club head has a noncircular cross-sectional shape, wherein at least a portion of an exterior surface of the head adapter has a noncircular cross-sectional shape that may be received within and engage the noncircular cross-sectional shape of the interior chamber in a non-rotational manner and in a plurality of different orientations.

4. The golf club of claim 3, wherein the noncircular cross-sectional shape of the exterior surface of the head adapter is defined by splines along the first axis and the noncircular cross-sectional shape of the interior chamber is defined by splines oriented to receive and engage with the splines on the exterior surface of the head adapter.

5. The golf club of claim 1, wherein the second axis of the shaft adapter is off-set from the first axis of the shaft adapter at about 1 degree.

6. The golf club of claim 1, wherein the second axis of the head adapter is off-set from the first axis of the shaft adapter at about 2 degrees.

7. The golf club of claim 1, wherein the securing structure includes a threaded hole defined in the second end of the shaft adapter and the securing system includes a threaded bolt element that engages the threaded hole through the shaft adapter.

8. A method for assembling a golf club comprising:
attaching a shaft member to a shaft adapter having a first end and a second end along a first axis, wherein the shaft member is inserted within a bore defined in the shaft adapter along a second axis, wherein at least a portion of an exterior surface of the shaft adapter has a noncircular cross-sectional shape, and the second end includes a securing structure;
inserting a head adapter into an interior chamber of a club head;
inserting the shaft adapter within a bore of the head adapter, wherein the head adapter comprises a first end and a second end along a first axis and wherein the bore has a noncircular cross-sectional shape along a second axis that is shaped to receive and engage the portion of the exterior surface of the shaft adapter having the noncircular cross-section in a non-rotational manner and in a plurality of different orientations;
placing a securing member into the second end of the shaft adapter; and
releasably engaging the securing member with the securing structure of the shaft adapter to thereby releasably engage the head adapter and the shaft adapter with the club head.

9. The method of claim 8, wherein the noncircular cross-sectional shape of the exterior surface of the shaft adapter is defined by splines along the first axis and the noncircular cross-sectional shape of the bore of the head adapter is defined by splines along the second axis of the head adapter and are oriented to receive and engage with the splines on the exterior surface of the shaft adapter.

10. The method of claim 8, wherein at least a portion of an exterior surface of the head adapter has a noncircular cross-sectional shape defined by splines along the first axis, and wherein at least a portion of an interior chamber of the club head has a noncircular cross-sectional shape defined by splines oriented to receive and engage with the splines on the exterior surface of the head adapter, and wherein when
inserting the head adapter into the hosel area of the club head, the splines of the exterior surface of the head adapter engage the splines in the interior chamber in a non-rotational manner.

11. The method of claim 8, wherein the head adapter is integrally formed as part of the interior chamber of the club head.

12. The method of claim 11, wherein the noncircular cross-sectional shape of the exterior surface of the shaft adapter is defined by splines along the first axis and the interior chamber of the club head has a noncircular cross-sectional shape defined by splines oriented to receive and engage with the splines on the exterior surface of the shaft adapter.

13. The method of claim 8, further comprising:
removing the securing member from the securing structure to thereby release the shaft adapter from the head adapter and reinserting the second end of the shaft adapter into the bore of the head adapter in a different orientation.

14. The method of claim 10, further comprising:
removing the securing member from the securing structure to thereby release the head adapter from the interior chamber of the club head and reinserting the head adapter into the hosel area of the club head in a different orientation.

15. The method of claim 10, wherein the second axis of the shaft adapter is off-set from the first axis of the shaft adapter at about 1 degree.

16. The method of claim 10, wherein the second axis of the head adapter is off-set from the first axis of the shaft adapter at about 2 degrees.

17. The method of claim 10, wherein the securing structure includes a threaded hole defined in the second end of the shaft adapter and the securing system includes a threaded bolt element that engages the threaded hole through the shaft adapter.

18. A golf club head and shaft connecting system, comprising:
a shaft adapter having a first end and a second end along a first axis, the shaft adapter further comprising a bore extending along a second axis configured to attach to a shaft member on the second axis, wherein at least a portion of an exterior surface of the shaft adapter is configured to engage a head adapter and has a cross-sectional shape defined by splines along the first axis, the second end including a securing structure;
a head adapter having a first end and a second end along a first axis, the head adapter further comprising a bore having a cross-sectional shape defined by splines along a second axis that are shaped to receive and engage with the splines provided on the exterior surface of the shaft adapter in a plurality of orientations, and wherein an exterior surface of the second end of the head adapter is configured to engage an interior chamber of a club head; and
a securing system for releasably engaging the securing structure, wherein the securing structure includes a threaded hole defined in the second end of the shaft adapter and the securing system includes a threaded bolt element that engages the threaded hole.

19. A golf club head and shaft connecting system of claim 18, further comprising:
instructions for instructing a person to perform a method of:
inserting a shaft member into the bore at the first end of the shaft adapter; and
inserting the second end of the shaft adapter into the bore of the head adapter in one of a plurality of different orientations.

20. The golf club head and shaft connecting system of claim 19, further comprising:
a club head having an interior chamber with a cross-sectional area defined by splines oriented to receive and engage with the second end of the head adapter, and wherein the instructions further instruct a person to perform the method of:
inserting the head adapter into the interior chamber of the club head at one of a plurality of different orientations.

21. The golf club head and shaft connecting system of claim 20, further comprising:
information relating to a face angle, a lie angle, and a loft angle of the club head in relation to at least one of different orientations of the shaft adapter and the head adapter with respect to one another or different orientations of the shaft adapter and the head adapter with respect to the hosel area of the club head.
